(19) United States
(12) Patent Application Publication
(10) Pub. No.: US 2007/0015112 A1
(43) Pub. Date: Jan. 18, 2007

(54) Teeth whitening apparatus and method

(76) Inventors: Mark Hochman, Lake Success, NY (US); Alan A. Creamer, Carlsbad, CA (US)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 11/481,193

(22) Filed: Jul. 5, 2006

Related U.S. Application Data
(63) Continuation-in-part of application No. 10/925,820, filed on Aug. 25, 2004.
(63) Continuation-in-part of application No. 11/120,113, filed on May 2, 2005.
(60) Provisional application No. 60/499,692, filed on Sep. 3, 2003.
(60) Provisional application No. 60/498,990, filed on Aug. 29, 2003.
(60) Provisional application No. 60/505,196, filed on Sep. 23, 2003.
(60) Provisional application No. 60/666,039, filed on Mar. 29, 2005.
(60) Provisional application No. 60/668,664, filed on Apr. 6, 2005.

(51) Int. Cl. A61C 5/00

(52) U.S. Cl. 433/215

(57) ABSTRACT

A dental whitening apparatus is provided that includes a body having a heating element and a light emitting device. The heating element and the light emitting device are disposed for activating a bleaching composition. A mouthpiece is connected with the body. The mouthpiece includes a dental receiving area that is formed of a material that facilitates transmission and emittance of light, and is contoured to a set of teeth. The dental receiving area has a first wall and a second wall that define a cavity. The cavity is configured for disposal of the bleaching composition. Methods of use are also disclosed.

### CROSS REFERENCE TO RELATED APPLICATIONS

This patent application is a continuation-in-part of U.S. Utility patent application Ser. No. 10/925,820, filed in the U.S. Patent and Trademark Office on Aug. 25, 2004 by Creamer and U.S. Utility patent application Ser. No. 11/120,113, filed in the U.S. Patent and Trademark Office on May 2, 2005 by Hochman, the entire contents of these disclosures being hereby incorporated by reference herein, application Ser. No. 10/925,820 claims the benefit of U.S. Provisional Patent Application Ser. No. 60/499,692, filed on Sep. 3, 2003, U.S. Provisional Application Ser. No. 60/498,990, filed on Aug. 29, 2003 and U.S. Provisional Application Ser. No. 60/505,196, filed on Sep. 23, 2003, the contents of these disclosures being incorporated herein by reference in their entirety; application Ser. No. 11/120,113 claims the benefit of U.S. Provisional Patent Application Ser. No. 60/666,039, filed on Mar. 29, 2005 and U.S. Provisional Application Ser. No. 60/668,664, filed on Apr. 6, 2005, the contents of these disclosures being incorporated herein by reference in their entirety.

### BACKGROUND

1. Technical Field

The present disclosure generally relates to dental health and dental cosmetics. More particularly, the present disclosure is directed to the cosmetic whitening of teeth through chemical activation and related dental compositions, such as bleaching compositions, used with a teeth whitening apparatus. Desirably, medications and compositions are distributed to the oral cavity to provide a safe, comfortable experience.

2. Description of the Related Art

Increasingly, it has become popular to whiten teeth that are naturally off white or have become stained by smoking or food intake. To whiten teeth in the past, people either have capped teeth or had veneers placed over them, which both entail costly and involved dental procedures. More recently, chemical bleaching of teeth has allowed people to whiten their teeth without resorting to these previously costly and involved dental procedures.

In early bleaching methods, dental patients desiring to have their teeth bleached had to utilize conventional dental office bleaching techniques. These techniques usually involved placing a peroxide solution on the teeth, protecting the sensitive soft tissues with a ligated rubber dam, and applying unregulated heat or light to the solution. Unfortunately, the lights used in dental office procedures are high power, high voltage lights that desiccate teeth and cause greater postoperative sensitivity. Such dental office treatments are extremely time consuming as they typically require multiple treatments for a significant color change. The need for multiple professional office visits results in a procedure that is costly. Further, these professional methods are primarily concerned with the whitening of the buccal, facial surface only.

Because of the time consuming nature of these multiple office visits and costs associated therewith, there has been a growing interest within the dental profession for in-home tooth bleaching products and methods. One particular in-home approach embeds various bleaching compositions onto substrates such as fabric or fiber strips that a patient applies to their teeth. The most commonly used dental bleaching compositions are 10% carbamide peroxide (CO(NH2)2 H2 O2), also called urea hydrogen peroxide, hydrogen peroxide carbamide, and perhydrol-urea.

While useful results have been experienced using the foregoing in-home techniques, their effectiveness has been largely dependent upon such factors as type and intensity of tooth enamel stain, bleaching agent contact time, and the amount of available active ingredient in the bleaching composition. Unfortunately, despite improvements in these in-home methods, there remain disadvantages and limitations to in-home bleaching products and techniques. A significant disadvantage of the known in-home approaches is the lack of patient compliance due to the long application or contact time required. Further drawbacks include a complicated application of bleaching composition to the teeth and the inability to effectively penetrate the surfaces of the teeth.

Attempts to overcome the disadvantages of the prior art include light-emitting whitening devices that use light energy to activate a bleaching composition. These types of devices use light to catalyze the bleaching composition at a specific wavelength. Other approaches have employed a substantially flat bite plate associated with a light source. See, for example, US Patent Publication No. 2005/0064371. These type designs, however, can suffer from various drawbacks such as less than desirable light application as well as being cumbersome to the user due to the requirement of a separate initial application of bleaching composition directly to the user's teeth.

Some patients also suffer from gingival recession resulting in sensitivity to hot and/or cold that prevents proper cleaning of the teeth and gums. Another concern is reducing the amount of micro-organisms and pathogens in the oral cavity to improve the health of the teeth and gums.

Therefore, it would be desirable to overcome the disadvantages and drawbacks of the prior art with a teeth whitening apparatus that can be employed with bleaching compositions and related methods that utilize chemical activation to facilitate fast and efficient treatment of tooth surfaces and/or gums. Such a teeth whitening apparatus, compositions, and methods provide a safe, comfortable patient experience with greater compliance and satisfaction. It would be desirable if the teeth whitening apparatus included a mouthpiece that is configured to facilitate activation of a chemical bleaching composition. The teeth whitening apparatus may include a temperature-regulated, heat-emitting capability that activates a chemical bleaching composition through controlled heat activation. The teeth whitening apparatus may also include vibration capabilities such as, for example, ultrasonic emitting elements that activate and distribute the chemical bleaching composition. It would also be desirable for such a teeth whitening apparatus to activate the bleaching composition, as well as other oral medications and compositions. It would be highly desirable if the teeth whitening apparatus, composition and methods prevent tissue damage and enable use by persons that suffer from sensitivity to achieve the principles of the present disclosure. It is contemplated that the teeth whitening apparatus and its constituent parts are easily and efficiently manufactured and assembled.

### SUMMARY

Accordingly, a teeth whitening apparatus is provided that can be employed with bleaching compositions and related methods that employ chemical activation to facilitate fast and efficient treatment of tooth surfaces and gums for a safe, comfortable patient experience with greater compliance and satisfaction for overcoming the disadvantages and drawbacks of the prior art. Desirably, the teeth whitening apparatus includes a dental tray, mouthpiece, etc. that is configured to facilitate activation of a chemical bleaching composition. The teeth whitening apparatus may include a temperature-regulated, heat-emitting capability that activates a chemical bleaching composition through controlled heat activation. A heat-emitting source may be included with the teeth whitening apparatus to generate and emit heat energy to activate the chemical bleaching composition. The teeth whitening apparatus may also include vibration capabilities such as, for example, ultrasonic emitting elements that activate and distribute the chemical bleaching composition. It would also be desirable for such a teeth whitening apparatus to activate chemical bleaching compositions and/or distribute other oral medications and compositions such as, for example, desensitizing agents and anesthetics. Most desirably, the teeth whitening apparatus, composition and methods prevent tissue damage and enable use by persons that suffer from sensitivity to achieve the principles of the present disclosure. The teeth whitening apparatus is easily and efficiently manufactured and assembled. The present disclosure resolves related disadvantages and drawbacks experienced in the art.

In one particular embodiment, in accordance with the present disclosure, a teeth whitening apparatus is provided that includes a heat-emitting dental tray having the ability to maintain a specified range of temperature of a person's biteplane for a predetermined purpose. The heat source emits heat energy in a temperature range that is controlled. One feature of providing a heat-emitting dental tray is to provide a thermal catalyst for activation of bleaching agents and intra-oral compounds, for example, peroxide based compounds. The heat activation of these agents and other chemicals allows catalyzation of a chemical reaction via heat initiation. Another feature of providing a thermal heat-emitting dental tray is for patient comfort for those individuals with tooth sensitivity as a result of gingival recession or other oral pathologies that lead to increased tooth sensitivity to hot and/or cold. Such a dental tray may also be employed to distribute other oral medications and compositions, such as, for example, the use of fluoride containing compositions, anti-microbial compositions, anesthetic gel compositions, etc.

The dental tray will allow compounds such as hydrogen peroxide based gels or dentifrices to more efficiently catalyze and release active ingredients enabling them to produce the desired whitening effect. In one embodiment, the dental tray includes a mouthpiece having a vessel configuration for delivery of chemical compositions. Such compositions can be mixed within a vessel of the mouthpiece for delivery thereof to enable placement of the composition directly to the teeth and gums for topical application. The mouthpiece can also provide a medium for transmission of energy relating to light, heat, ultrasound and vibratory motion. In this configuration that the composition, which may include a bleaching agent, fluoride, etc. is used as a distinct interface medium between the target-teeth/gums and the energy source. This advantageous configuration avoids the drawbacks of direct contact with the teeth, for operation as in some prior art designs. The dental tray configuration has indirect operation via the composition medium placed within the mouthpiece. Alternatively, the dental tray can also allow distribution of medication to treat pain, as well as protect and clean teeth. Such a dental tray can be configured for use with infants, children, adults and geriatrics. For example, this configuration will advantageously enable infants to be soothed during the teething phase of tooth eruption.

The teeth whitening apparatus, compositions and methods disclosed embody improvements over the prior art by enabling a safer, more reliable activation of chemical processes through the application of thermal heat, ultrasound, light and vibration energy with or without a regulated range of temperature. The dental tray also can distribute compositions for anti-microbial properties, pain obtunding, and desensitization. The dental tray of the teeth whitening apparatus, compositions and methods disclosed include several benefits and features including:

1. Allowing the use of heat activated chemicals, or chemical compounds that can be catalyzed for specific therapeutic applications in the oral cavity by topical placement of an innovative dental tray;

2. Allowing the use of medications intra-orally that are activated via the use of heat from the dental tray;

3. Allowing patients with sensitivity to more effectively desensitize teeth by utilizing the dental tray in a regulated range of temperature to raise or lower the temperature of the agent, gel, etc. to a desirable physiological range;

4. Improving circulation within the soft tissues and gums of the oral cavity, thereby improving general oral health;

5. Facilitating a phase change of a chemical compound or bleaching agent, such as from a gel to a liquid of a lower viscosity so that the compound or agent can be more readily distributed about the teeth. This distribution of a gel or compound for greater teeth coverage, results in a lower amount of gel or compound being used. For example, the heating of a hard wax or compound to a soft, pliable or workable material is contemplated;

6. Employing a vessel of the mouthpiece to enable mixing of composition ingredients within the mouthpiece. The dental tray can then use an energy source of light, heat, ultrasonic and/or vibration for mixing and activation of a composition disposed within the vessel, including placement of the dental tray within an oral cavity;

7. A composition placed within the vessel provides an intervening or a direct composition medium that transmits energy to the intended final target of the teeth or gums. Such a mouthpiece vessel mixes the composition and delivers the composition directly to the teeth and/or gums; and

8. A mouthpiece with a vessel having openings or perforations with the occlusal bite plane allows the ingredients of a composition to mix from an upper compartment of the vessel to a lower compartment of the vessel. These openings will also serve as a reservoir for the composition during an application phase of teeth treatment.

Further, the use of a heat-emitting source allows tissues adjacent that are not within a direct line of sight, to benefit from the heat, ultrasonic, and vibratory energy. This configuration allows a more effective means of chemical activation to occur by use of a direct source.

A heat source, such as, for example a heat-emitting diode can be contained within the dental tray. Alternatively, the heat source may be disposed in a biteplane, and may include a sensor in the biteplane or adjacent to the biteplane. It is contemplated that composition of the material used for the mouthpiece will transfer heat, ultrasonic movement, ultrasonic sound and vibration to the chemical composition and soft tissues.

It is also contemplated that such a heat-emitting dental tray may have a beneficial effect on the circulation of the soft tissues, gums and periodontium, enhancing circulation to the tissues. The use of the vibration, ultrasonic, ultrasound and heat-emitting energy with the mouthpiece improves circulation to the gum tissues and has a beneficial effect on the general health of the gingival tissues.

In addition, the teeth whitening apparatus, by producing a rise in temperature, can result in greater circulation that can allow more effective resistance to infection. Using the teeth whitening apparatus can also raise the temperature of the oral cavity to destroy microorganisms that are pathologic in nature.

In another embodiment, in accordance with the principles of the present disclosure, a method for whitening teeth, reducing micro-organisms and/or desensitizing portions of the oral cavity, such as the teeth and gums. The method includes the steps of:

a) Mixing a composition of compounds which is placed into the mouthpiece vessel to be mixed. It is envisioned that a specified amount of time may be required for mixing the compounds extra-orally prior to placement into mouth;

b) Mixing compounds placed into the mouthpiece vessel with activation of the compound provided by the mouthpiece via an energy source of the dental tray, similar to those discussed;

c) Using the dental tray to deliver the composition to the oral cavity to be applied directly to teeth and gums; and

d) Removing the dental tray containing residual composition from the oral cavity to be discarded.

In another embodiment, an alternate method in accordance with the present disclosure for whitening teeth, reducing micro-organisms and/or desensitizing portions of the oral cavity is disclosed. The method includes steps of:

a) Placing a composition into the mouthpiece vessel. It is envisioned that a specified amount of time may be required for mixing the composition extra-orally prior to placement into mouth;

b) Activating of the composition provided by the mouthpiece via energy source within the mouthpiece vessel;

c) Using the mouthpiece to deliver the composition to the oral cavity to be applied directly to teeth and gums; and

d) Removing the mouthpiece containing residual mixture from the oral cavity to be discarded.

The present disclosure also provides an apparatus and method for teeth desensitization. The dental tray allows the placement of fluoride containing medications or other medications formulated for tooth desensitization using a specified temperature to warm the composition prior to placement on teeth and roots of teeth. To enable more effective penetration around and in-between teeth, as well as more effective penetration into the dentinal tubules of teeth. The desensitizing composition may also use ultrasonic sound and vibratory motions to distribute the desensitizing composition more effectively.

The use of multiple forms of energy, such as, for example, light, heat, vibration, audio and ultrasound will synergistically work in combination to effectively alter and or destroy micro-organisms of the oral cavity. The teeth whitening apparatus avoids drawbacks of the prior art by reducing gingival recession. The use of the ultrasonic, light, and/or heat emitting dental tray containing a specific anti-microbial composition to destroy oral micro-organisms benefits patients. The configuration of the dental tray reduces oral plaque upon teeth via the use of an anti-microbial composition. Ultrasonic energy in combination with light and heat effectively reduces pathogenic organisms by distributing the composition in direct contact to the offending organisms and indirectly transmitting sources of energy that will optimize the reduction in micro-organisms.

It is also understood that infants suffer from pain and discomfort during the teething phase of tooth eruption. The dental tray of the present disclosure employs vibration, heat and/or ultrasonic energy for drug delivery. This configuration enables placement of an anesthetic gel safely upon the infant's gums to minimize pain and suffering. The dental tray vibration offers a soothing distraction to the distressed infant. In addition, the dental tray provides an effective vessel to selectively apply a numbing composition to gums and teeth. Sensitive gums in combination with erupting teeth present a particular challenge. Further, the dental tray can apply anti-microbial agents to prevent tooth decay in infants and growing children. Additionally, the dental tray applies protecting compositions to the teeth, such as fluoride during the developmental years.

In one particular embodiment, in accordance with the principles of the present disclosure a dental whitening apparatus is provided that includes a body having a heating element and a light emitting device. The heating element and the light emitting device are disposed for activating a bleaching composition. A mouthpiece is connected with the body. The mouthpiece includes a dental receiving area that is formed of a material that facilitates transmission and emittance of light, and is contoured to a set of teeth. The dental receiving area has a first wall and a second wall that define a cavity. The cavity is configured for disposal of the bleaching composition.

The dental whitening apparatus may include a thermal sensor that is disposed adjacent the dental receiving area and configured to sense temperature of the bleaching composition. A temperature of the bleaching composition is regulated by a thermal feedback circuit communicating with the thermal sensor and a thermostat disposed with the body to control heat activation of the bleaching composition.

The bleaching composition may include at least two separate ingredients that are mixed in the cavity of the dental receiving area. At least one medication may be disposed in the cavity of the dental receiving area, which may include a fluoride, anti-microbial agent, anesthetic, and desensitizing agent.

In one particular embodiment, in accordance with the principles of the present disclosure a tablet formulation containing a metal ion catalyst and an alkaline pH raising compound is chewed by a patient followed by rinsing their teeth with a peroxide composition having a concentration of about 1 percent to about 35 percent peroxide by weight. The combination of the tablet formulation containing the metal ion within an alkaline composition along with the peroxide rinse forms a dental composition having foam like consistency, which whitens substantially all of the surfaces of the patient's teeth. The process of whitening the patient's teeth is accelerated by using a light-emitting device according to the disclosure producing a selected wavelength range to assist the decomposition of the peroxide intra orally by activating the metal ion catalyst within the dental composition. The light emitting device can be incorporated into a dental receiving area that captures the whitening composition and holds the whitening composition on the surface of the teeth.

In a further embodiment, according to the disclosure, a solution having a gel consistency comprising selected peroxides and selected transitional metal ions, such as ionized silver, zinc, manganese or the like is sprayed onto the surface of a patient's teeth. The sprayed solution is followed by a rinse of an additional low concentration peroxide, such as hydrogen period or carbamide peroxide, or calcium peroxide. The additional peroxide can be applied to the teeth using a dental receiving area according to the disclosure or by merely rinsing the oral cavity with a low concentration solution. The dental receiving area according to the disclosure can further include a light source having a selected wavelength that activates the metal ion within the dental composition. The pH of the above spray is adjusted to about 6 to about 8 or above by the use of an alkaline agent, which allows for a faster decomposition of the peroxide. The light source is directed within the oral cavity for a period of about two minutes to about 20 minutes. The selected light source activates the photo sensitive metal ions and further produces heat hastening the decomposition of peroxides thereby accelerating the whitening effect.

The body of the dental receiving area according to the disclosure may include a vibratory element disposed in a configuration for mixing the bleaching composition disposed in the cavity of the dental receiving area. The vibratory element can include an ultrasonic energy element and an acoustic element. The cavity can support the bleaching composition in a configuration such that the bleaching composition is a medium for transmission of heat energy from the heating element and light energy from the light emitting device to the set of teeth. The dental receiving area may include a biteplane wall that extends between the first wall and the second wall. The biteplane wall may include at least one opening, and desirably, a plurality of openings. The biteplane wall can separate a first compartment and a second compartment of the dental receiving area. The biteplane wall may be disposed in a perpendicular orientation relative to the first and second walls. The first and second walls may have rounded edges.

The dental whitening apparatus may include an electronic circuit disposed with the body, which communicates with the thermal sensor, the thermostat and the energy source for controlling operation of the dental whitening apparatus. The thermostat can have a predetermined upper limit and a predetermined lower limit. A rheostat temperature control may be included that is disposed with the body that communicates with the electronic circuit in a configuration that controls the temperature adjacent the cavity of the dental receiving area at a predefined value. A timer may be disposed with the body that communicates with the electronic circuit in a configuration that transmits heat or light energy for a predetermined amount of time.

In another embodiment, a method for whitening teeth is disclosed including the steps of: providing a dental whitening apparatus adapted for use with a subject having a set of teeth; providing a first ingredient of the bleaching composition to the cavity of the dental receiving area; providing a second ingredient, separate from the first ingredient, of the bleaching composition to the cavity of the dental receiving area; mixing the first ingredient and the second ingredient in the cavity to form the bleaching composition; placing the dental whitening apparatus such that the set of teeth are disposed within the cavity of the dental receiving area such that the bleaching composition engages the set of teeth; and transmitting heat energy from the heating element and light energy from the light emitting device to the bleaching composition engaging the set of teeth for activating the bleaching composition.

The step of mixing can include mixing the first ingredient and the second ingredient for a predetermined period of time. The step of mixing can occur prior to the step of placing. The step of transmitting may include transmitting heat energy and light energy for a predetermined period of time. The method may further include the step of providing at least one medication to the bleaching composition, prior to the step of mixing. In an alternate embodiment, the method for whitening teeth includes the step of vibrating the dental receiving area, via the vibratory element, to mix the first ingredient and the second ingredient. The step of vibrating may include vibrating the dental receiving area for a predetermined period of time. The method may include the step of vibrating the dental receiving area and the bleaching composition disposed therein, subsequent to the step of placing, to distribute the bleaching composition and/or at least one medication disposed therein about and between the set of teeth.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawing, as set forth below.

FIG. 1 is a side view of a teeth whitening apparatus, with internal components shown, in accordance with the principles of the present disclosure;

FIG. 2 is a side view of an alternate embodiment of the teeth whitening apparatus illustrated in FIG. 1, with internal components shown;

FIG. 3 is a side view of another alternate embodiment of the teeth whitening apparatus illustrated in FIG. 1, with internal components shown;

FIG. 4 is a side view of another alternate embodiment of the teeth whitening apparatus illustrated in FIG. 1, with internal components shown;

FIG. 5 is a side view of another alternate embodiment of the teeth whitening apparatus illustrated in FIG. 1, with internal components shown;

FIG. 6 is a side view of another alternate embodiment of the teeth whitening apparatus illustrated in FIG. 1, with internal components shown;

FIG. 7 is a flow diagram depicting an illustrative method in accordance with the present disclosure;

FIG. 8 is a flow diagram depicting an alternative illustrative method in accordance with the present disclosure;

FIG. 9 is a plan view of a teeth whitening apparatus in accordance with the present disclosure, with a cover removed to show internal components;

FIG. 10 is a side perspective view of the teeth whitening apparatus shown in FIG. 9, with parts separated;

FIG. 11 is a plan view of another alternate embodiment of the teeth whitening apparatus in accordance with the present disclosure with internal components shown;

FIG. 12 is side view of a mouthpiece of the teeth whitening apparatus shown in FIG. 11;

FIG. 13 is an alternate embodiment of the teeth whitening apparatus shown in FIG. 11, with internal components shown;

FIG. 14 is another alternate embodiment of the teeth whitening apparatus shown in FIG. 11, with internal components shown;

FIG. 15 is another alternate embodiment of the teeth whitening apparatus shown in FIG. 11, with internal components shown;

FIG. 16 is another alternate embodiment of the teeth whitening apparatus shown in FIG. 11, with internal components shown;

FIG. 17 is a side view of an alternate embodiment of the mouthpiece shown in FIG. 12;

FIG. 18 is a side view of an alternate embodiment of the mouthpiece shown in FIG. 12;

FIG. 19 is a plan view of an alternate embodiment of the mouthpiece shown in FIG. 11; and

FIG. 20 is a plan view of an alternate embodiment of the mouthpiece shown in FIG. 11.

### DETAILED DESCRIPTION OF EXEMPLARY EMBODIMENTS

The exemplary embodiments of the teeth whitening apparatus, composition and methods of use disclosed are discussed in terms of dental health and dental cosmetics and more particularly, in terms of a teeth whitening apparatus that can be employed with bleaching compositions and related methods that utilize chemical activation to facilitate fast and efficient treatment of tooth surfaces and or gums. The teeth whitening apparatus may include ultrasonic, acoustic, vibratory motion, light, or temperature regulated heat activation to facilitate fast and efficient treatment of tooth surfaces and/or gums. It is envisioned that the present disclosure may be employed with a range of teeth whitening applications including portable, in-home and in-office. It is further envisioned that the present disclosure may be used with other medical applications, including diagnostic, treatment and surgical.

The device can be a single hand held device or can be a device that is extra-oral used for the purpose of therapeutic treatment. The device can be a consumer device “at-home” or can be a professional device used “in-office”. The device could have bristles attached to allow cleaning, massage and contact of the oral tissues. The device could be used solely for the purpose of activating chemical compounds or materials in the dental field. As used herein, the term “subject” refers to a human patient or other animal.

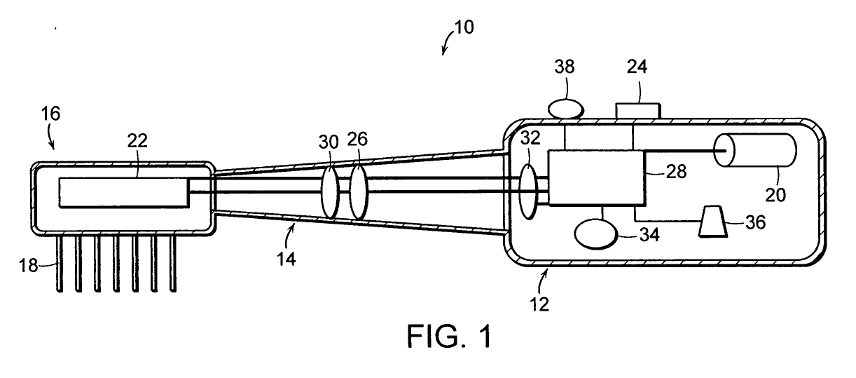

The following discussion includes a description of the teeth whitening apparatus and composition in connection with an exemplary method of operating the teeth whitening apparatus and composition in accordance with the principles of the present disclosure. Alternate embodiments are also disclosed. Reference will now be made in detail to the exemplary embodiments of the present disclosure, which are illustrated in the accompanying figures. Turning now to FIG. 1, there is illustrated a teeth whitening apparatus, such as, for example, a toothbrush 10, in accordance with the principles of the present disclosure.

The components of toothbrush 10 are fabricated from materials suitable for dental applications, such as, for example, polymerics or metals, depending on the particular application and/or preference. Semi-rigid and rigid polymerics are contemplated for fabrication, as well as resilient materials, such as molded medical grade polyurethane, or the like. The electronic, heat generating and temperature sensing components of toothbrush 10 may be fabricated from those suitable for a dental application. One skilled in the art, however, will realize that other materials and fabrication methods suitable for assembly and manufacture, in accordance with the present disclosure, also would be appropriate.

Detailed embodiments of the present disclosure are disclosed herein, however, it is to be understood that the described embodiments are merely exemplary of the disclosure, which may be embodied in various forms. Therefore, specific functional details disclosed herein are not to be interpreted as limiting, but merely as a basis for the claims and as a representative basis for teaching one skilled in the art to variously employ the present disclosure in virtually any appropriately detailed embodiment.

Toothbrush 10 includes a body having a handle 12, a neck 14 and a head 16. Head 16 has bristles 18 attached to allow cleaning, massage and contact of oral tissues (not shown). The body of toothbrush 10 may have various configurations and dimensions, according to the particular application, such as, for example, tapered cross section, circular cross section, polygonal, etc.

An energy source 20 is disposed within handle 12 of toothbrush 10 for providing an energy source for a heating element 22. Energy source 20 may be disposed in other portions of toothbrush 10. It is contemplated that energy source 20 may include alternate sources of energy, such as, for example, an A/C power source, rechargeable batteries, replaceable batteries, etc. It is also contemplated that a sealed single-use battery may provide the energy source to heating element 22. Energy source 20 is connected to an electronic circuit board 28, disposed within handle 12, for operating toothbrush 10, as will be discussed. An on/off switch 24 is disposed on handle 12 of toothbrush 10 for connection with electronic circuit board 28 and an on/off indicator 26 of toothbrush 10. Indicator 26 may include a LED, bulb, or the like to provide visual indicia of the on/off status of toothbrush 10.

Toothbrush 10 is employed for the cosmetic whitening of teeth (not shown) through thermal chemical activation processes. Toothbrush 10 activates a chemical bleaching composition through controlled heat activation, which is temperature regulated, as described herein. On/off switch 24 is manipulated to turn toothbrush 10 on, with on/off indicator 26 displaying status via electronic circuit board 28.

On/off switch 24, via electronic circuit board 28, enables powering of heating element 22 from energy source 20. Visual indicia and/or audible indicia is provided that alerts the user to the on/off status of heating element 22. An on/off indicator 30, connected to an electronic circuit board 28, indicates that heating element 22 is transmitting heat energy to adjacent bristles 18. Indicator 30 may include a LED, bulb, or the like to provide visual indicia of the on/off status of heating element 22. It is further envisioned that a light or series of lights on various portions of the body of toothbrush 10 such as, neck 14 and/or handle 12 allows the user to be aware of the status of heating element 22.

Heating element 22 is disposed with head 16 and in an orientation to transmit heat energy adjacent bristles 18. Heating element 22 is configured to transmit heat energy adjacent head 16 and bristles 18 to activate a chemical bleaching composition for cosmetic whitening of a patient's teeth. The temperature or range of temperature can be maintained by use of electronic circuit board 28, which is connected to a thermostat 32 with a feed-back loop circuit of board 28. It is envisioned that thermostat 32 includes a temperature sensor disposed about head 16 and bristles 18 for monitoring temperature adjacent thereto. This configuration is employed to monitor and control the temperature adjacent head 16 and bristles 18 according to the heat being emitted from heating element 22. Thermostat 32 is pre-set such that the upper limit and lower limit of the temperature can be controlled. It is contemplated that a single range of temperature is pre-set for use or that the user would be able to adjust the range of temperature. It is also contemplated that a single temperature could be adjusted. The temperature sensor connected with thermostat 32 may be disposed at various positions about toothbrush 10. It is envisioned that various temperature sensors may be used that are suitable for dental applications, such as, for example, thermistor, thermocouple, RTDs, infrared, fiber optic, microchip, or the like.

Electronic circuit board 28 and the related circuitry of toothbrush 10 may employ those components known to one skilled in the art that are suitable for a dental application. It is envisioned that toothbrush 10 may include a processor, printed circuit board or microprocessor components that operate and control the components of toothbrush 10, suitable for teeth whitening applications.

The chemical bleaching composition employed with toothbrush 10 is applied to the teeth of a subject. Toothbrush 10 is manipulated to brush the chemical bleaching composition about the teeth and oral cavity as required for a particular dental teeth whitening application. Heating element 22 transmits heat energy to adjacent bristles 18.

A rheostat temperature control 38, connected with electronic circuit board 28, regulates the temperature in a specified range to control transmission of heat energy and corresponding heat activation of the chemical bleaching composition. Rheostat temperature control 38 can be set to pre-defined levels such as, for example, low, medium, high. Alternatively, rheostat temperature control 38 may regulate numerically defined temperature ranges. The chemical bleaching composition may include various teeth whitening agents, such as, for example, gels, powders, pastes, waxes and combinations thereof including hydrogen peroxide based chemicals, carbamide peroxide, calcium peroxide, potassium peroxide, or the like. It is contemplated that a plurality of agents or compounds may be employed.

An internal timer 34, connected with electronic circuit board 28, controls the duration of heat energy transmitted from heating element 22 to allow heat activation for a specific amount of time. The length of time can be adjusted according to the particular application. A speaker 36, connected with electronic circuit board 28, provides an audible signal indicating that a specified duration of heat energy transmission has elapsed. In turn, this indicates that use of toothbrush 10 is complete for tooth whitening. It is contemplated that several audible signals could be used to designate specific durations of heat energy transmission corresponding to a particular area of the oral cavity and that it is time to move to another random or predetermined area.

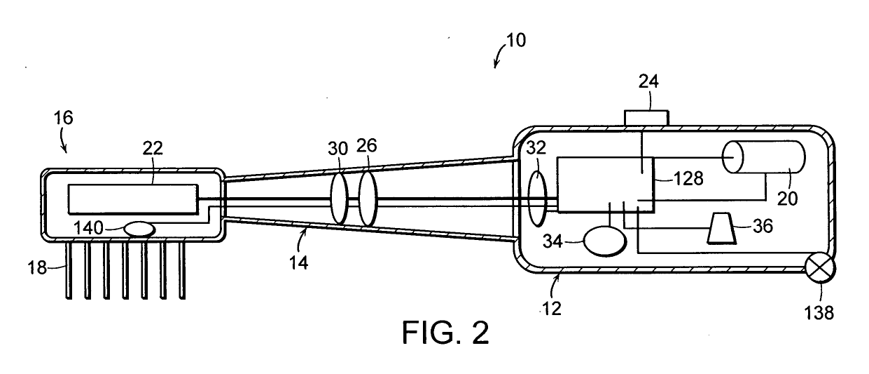

Referring to FIG. 2, an alternate embodiment of toothbrush 10, similar to that described, is shown. An electronic circuit board 128 is disposed with handle 12 of toothbrush 10. Electronic circuit board 128 is connected to the various components of toothbrush 10, similar to electronic circuit board 28 described above.

Electronic circuit board 128 is also connected to a thermal sensor 140 that is disposed with head 16 and adjacent heating element 22. Thermal sensor 140 detects temperature data adjacent head 16 and bristles 18 and sends the temperature data to electronic circuit board 128 and thermostat 32 to monitor and control the temperature of the heat being emitted from heating element 22. Thermal sensor 140 provides continuous feedback to electronic circuit board 128 and thermostat 32 to monitor and control temperature to regulate the process of whitening. It is contemplated that thermal sensor 140 may be disposed at various positions about toothbrush 10. It is further contemplated that thermal sensor 140 may be separate or integrated with heating element 22. Thermal sensor 140 can be disposed within toothbrush 10 or external to toothbrush 10, such as on the surface of head 18 or within a bristle or bristles 18.

A rheostat temperature control 138, connected with electronic circuit board 128, regulates the temperature in a specified range to control transmission of heat energy and corresponding heat activation of the chemical bleaching composition. Rheostat temperature control 138 has a manipulable dial configuration regulating temperature in a defined temperature range. It is contemplated that control 138 may regulate temperature in a temperature range of about 70°-140° F. Rheostat temperature control 138 can be manipulated or rotated to a desired temperature.

In operation, similar to that described above, toothbrush 10 includes thermostat 32 that sets a predefined temperature range for heating element 22 for heat activation of a chemical bleaching composition. Heating element 22 generates heat energy corresponding to the preset temperature range. Thermal sensor 140 detects temperature data adjacent head 16 and bristles 18 and sends the temperature data to electronic circuit board 128 and thermostat 32 to monitor and control the temperature adjacent head 16 and bristles 18 according to the heat being emitted from heating element 22. The thermal data from thermal sensor 140 provides the data such that electronic circuit board 128 and thermostat 32 can regulate the temperature to the defined range set by thermostat 32. These elements control a specific range of temperature at the point of application, thereby detecting temperature that is external to electronic circuit board 128 to be used to control the system.

Alternatively, the temperature regulated heat emission from toothbrush 10 for heat activation of the chemical bleaching composition can facilitate a phase change of the composition or agent. For example, the emission of heat from heating element 22 may cause a phase change of the agent, such as from a higher viscosity gel to a liquid of a lower viscosity. This phase change to a lower viscosity more readily distributes the agent about the subject's teeth. This distribution provides for a greater coverage of teeth and lower amount of agent being used.

In another alternate illustrative embodiment, thermal sensor 140 may include a filament that detects temperature either within toothbrush 10 or outside toothbrush 10. The filament directs temperature data to electronic circuit board 128 and thermostat 32 to monitor and control the temperature of the heat being emitted from heating element 22. This controller configuration of toothbrush 10 collects temperature data from thermal sensor 140 and directs temperature data to electronic circuit board 128 and thermostat 32. It is contemplated that one or a plurality of filaments may be disposed with bristles 18 to provide direct temperature sensing at the interface of contact to oral cavity surfaces such as the teeth or gums.

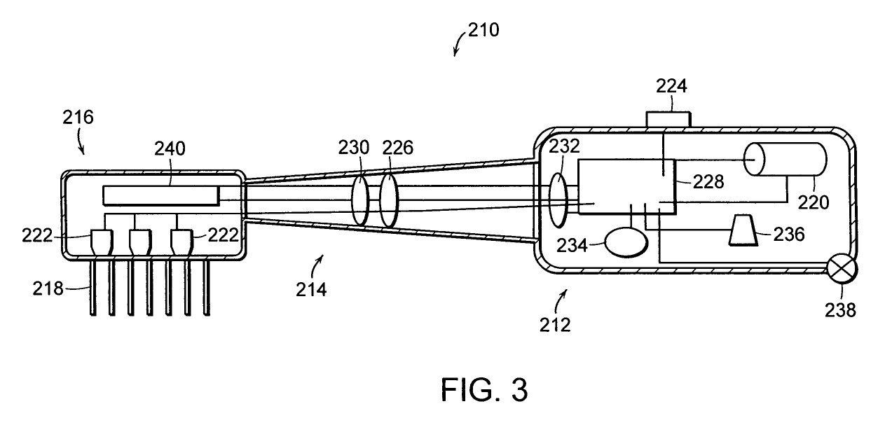

Referring to FIG. 3, an alternate embodiment, similar to toothbrush 10 described above, is shown that includes a toothbrush 210 having a body including a handle 212, a neck 214 and a head 216. Head 216 has bristles 218 attached to allow cleaning, massage and contact of oral tissues (not shown). The body of toothbrush 210 may have various configurations and dimensions, according to the particular application, such as, for example, tapered cross section, circular cross section, polygonal, etc.

An energy source 220 is disposed within handle 212 of toothbrush 210 for providing an energy source for a light-emitting source, such as, for example, light-emitting diodes (LEDs) 222. Energy source 220 may be disposed in other portions of toothbrush 210. It is contemplated that energy source 220 may include alternate sources of energy, such as, for example, an A/C power source, rechargeable batteries, replaceable batteries, etc. It is also contemplated that a sealed single-use battery may provide the energy source to LEDs 222. Energy source 220 is connected to an electronic circuit board 228, disposed within handle 212, for operating toothbrush 210, as will be discussed. An on/off switch 224 is disposed on handle 212 of toothbrush 210 for connection with electronic circuit board 228 and an on/off indicator 226 of toothbrush 210. Indicator 226 may include a LED, bulb, etc. to provide visual indicia of the on/off status of toothbrush 210.

Toothbrush 210 is employed for the cosmetic whitening of teeth (not shown) through thermal and or light chemical activation processes. Toothbrush 210 activates a chemical bleaching composition through controlled heat and or light activation, which is temperature regulated, as described herein. On/off switch 224 is manipulated to turn toothbrush 210 on, with on/off indicator 226 displaying status via electronic circuit board 228.

On/off switch 224, via electronic circuit board 228, enables powering of LEDs 222 from energy source 220. Visual indicia and/or audible indicia is provided that alerts the user to the on/off status of LEDs 222. An on/off indicator 230, connected to an electronic circuit board 228, indicates that LEDs 222 are transmitting heat and light energy to adjacent bristles 218. Indicator 230 may include a LED, bulb, or the like to provide visual indicia of the on/off status of LEDs 222. It is further envisioned that a light or series of lights on various portions of the body of toothbrush 210 such as, neck 214 and/or handle 212 allows the user to be aware of the status of LEDs 222.

LEDs 222 are disposed with head 216 and in an orientation to transmit heat and light energy to adjacent bristles 218. LEDs 222 are configured to emit visible light adjacent head 216 and bristles 218 within any range of wavelength that produces heat as its by-product. LEDs 222 are configured to transmit heat and light energy to adjacent head 216 and bristles 218 to activate a chemical bleaching composition for cosmetic whitening of a patient's teeth. One or a plurality of LEDs 222 may be employed. It is contemplated that other sources of light and heat energy may be employed.

The temperature or range of temperature can be maintained by use of electronic circuit board 228, which is connected to a thermostat 232 with a feedback loop circuit of board 228. It is envisioned that thermostat 232 includes a temperature sensor disposed about head 216 and bristles 218 for monitoring temperature adjacent thereto. For example, electronic circuit board 228 is also connected to a thermal sensor 240 that is disposed with head 216 and adjacent LEDs 222. Thermal sensor 240 detects temperature data adjacent head 216 and bristles 218 and sends the temperature data to electronic circuit board 228 and thermostat 232 to monitor and control the temperature adjacent head 216 and bristles 218 according to the heat being emitted from LEDs 222. Thermal sensor 240 provides continuous feedback to electronic circuit board 228 and thermostat 232 to monitor and control temperature to regulate the process of whitening. It is contemplated that thermal sensor 240 may be disposed at various positions about toothbrush 210. It is further contemplated that thermal sensor 240 may be separate or integrated with LEDs 222. Thermal sensor 240 can be disposed within toothbrush 210 or external to toothbrush 210, such as on the surface of head 216 or within a bristle or bristles 218. This configuration is employed to monitor and control the temperature adjacent head 216 and bristles 218 according to the heat being emitted from LEDs 222.

Thermostat 232 is pre-set such that the upper limit and lower limit of the temperature can be controlled. It is contemplated that a single range of temperature is pre-set for use or that the user would be able to adjust the range of temperature. It is also contemplated that a single temperature could be adjusted. The temperature sensor connected with thermostat 232 may be disposed at various positions about toothbrush 210. It is envisioned that LEDs 222 transmit light and heat energy to adjacent head 216 activating the chemical bleaching composition for cosmetic whitening of a patient's teeth.

Electronic circuit board 228 and the related circuitry of toothbrush 210 may employ those components known to one skilled in the art that are suitable for a dental application. It is envisioned that toothbrush 210 may include a processor, printed circuit board or microprocessor components that operate and control the components of toothbrush 210, suitable for teeth whitening applications.

The chemical bleaching composition employed with toothbrush 210 is applied to the teeth of a subject. Toothbrush 210 is manipulated to brush the chemical bleaching composition about the teeth and oral cavity as required for a particular dental teeth whitening application. LEDs 222 transmit light and heat energy to adjacent bristles 218. It is contemplated that LEDs 222 can transmit both light and heat energy.

A rheostat temperature control 238, connected with electronic circuit board 228, regulates the temperature in a specified range to control transmission of heat energy and corresponding heat activation of the chemical bleaching composition. Rheostat temperature control 238 can be set to pre-defined levels such as, for example, low, medium, high. Rheostat temperature control 238 has a manipulable dial configuration regulating temperature in a defined temperature range. It is contemplated that control 238 may regulate temperature in a temperature range of about 70°-140° F. Rheostat temperature control 238 can be manipulated or rotated to a desired temperature. Alternatively, rheostat temperature control 238 may regulate numerically defined temperature ranges.

An internal timer 234, connected with electronic circuit board 228, controls the duration of heat and light energy transmitted from LEDs 222 to allow heat and light activation for a specific amount of time. The length of time can be adjusted according to the particular application. A speaker 236, connected with electronic circuit board 228, provides an audible signal indicating that a specified duration of heat and light energy transmission has elapsed. In turn, this indicates that use of toothbrush 210 is complete for tooth whitening. It is contemplated that several audible signals could be used to designate specific durations of heat energy transmission corresponding to a particular area of the oral cavity and that it is time to move to another random or predetermined area.

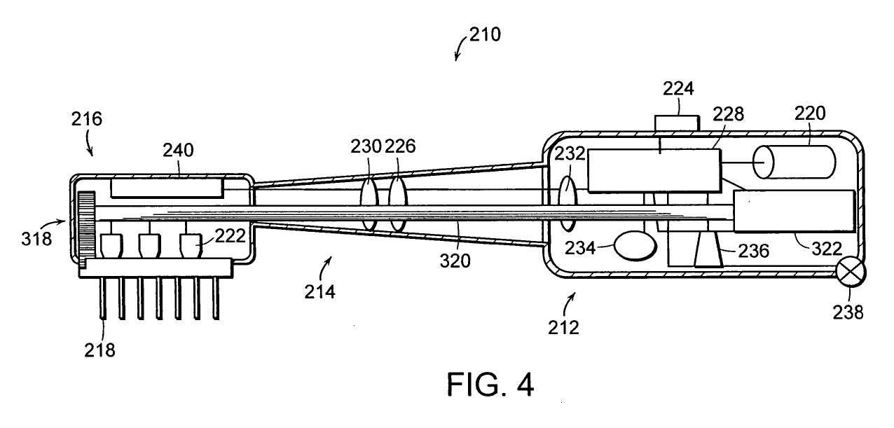

Referring to FIG. 4, an alternate embodiment of toothbrush 210, similar to that described, is shown. Bristles 218, disposed with head 216, are actuated via a bristle gear 318. Bristle gear 318 is linked to a shaft 320 that is connected to a motor 322. Motor 322 is connected to energy source 220 for activation thereof. It is contemplated that bristles 218 may be activated by manual or mechanical structure, including motorized, that can include the necessary electronics and/or processor circuitry to enable activation of bristles 218.

Bristles 218 may be disposed in various arrangements and orientations, including spaced apart, rotating bristle sets, etc. Activation of bristles 218 includes rotation and/or vibratory movement in various directions. Such movement of bristles 218 may include rotatable, vertical, horizontal and elliptical motion. Bristles 218 may also be heated with a filament and/or contain a therapeutic agent.

Motor 322 is connected to electronic circuit board 228 for operation and activation of bristles 218. It is contemplated that motor 322 may be connected with thermal sensor 240 such that a specific temperature or temperature range causes shut-off of bristle 218 activation. Bristles 218 may include continuous movement and/or periodic timed activation.

Activation of bristles 218 enhances cleaning, massage and contact of oral tissues. This configuration also enhances dispersal of a chemical bleaching composition about the teeth to facilitate teeth whitening.

In operation, similar to that described above, toothbrush 210 includes thermostat 232 that sets a predefined temperature range for LEDs 222 for heat and light activation of a chemical bleaching composition. LEDs 222 generate heat and light energy corresponding to the preset temperature range. Thermal sensor 240 detects temperature data adjacent head 216 and bristles 218 and sends the temperature data to electronic circuit board 228 and thermostat 232 to monitor and control the temperature adjacent head 216 and bristles 218 according to the heat and light being emitted from LEDs 222. The thermal data from thermal sensor 240 provides the data such that electronic circuit board 228 and thermostat 232 can regulate the temperature to the defined range set by the thermostat 232. These elements control a specific range of temperature at the point of application, thereby detecting temperature that is external to electronic circuit board 228 to be used to control the system.

Alternatively, the temperature regulated heat emission from toothbrush 210 for heat activation of the chemical bleaching composition can facilitate a phase change of the composition or agent. For example, the emission of heat from heating element 222 may cause a phase change of the agent, such as from a higher viscosity gel to a liquid of a lower viscosity. This phase change to a lower viscosity more readily distributes the agent about the subject's teeth. This distribution provides for a greater coverage of teeth and lower amount of agent being used. This phase change of the agent may also be accompanied by vibratory action of head 216 and/or bristles 218 to facilitate enhanced distribution of the agent about the surfaces of the teeth.

In another alternate embodiment, toothbrush 210, similar to that described with regard to FIGS. 3 and 4, activates a chemical teeth whitening agent, such as a whitening gel or toothpaste, in a two phase activation cycle. For example, LEDS 222 emit heat, as described, in a first phase that employs heat to cause the molecules of the agent or compound to become excited and reactive for teeth whitening applications. In a second phase, the light emitted from LEDS 222 would cause a further and separate excitation and reaction of the compound molecules for teeth whitening. Thus, toothbrush 210 employs a first phase of heat emission and a second phase of light emission for separate chemical reactions in a single teeth whitening application. This two phase activation cycle may include vibratory action, as discussed. It is contemplated that this two phase activation may occur simultaneously or in separate and distinction phases.

In another alternate embodiment, similar to that described with regard to FIGS. 3 and 4, toothbrush 210 is employed with a method of teeth whitening that includes a series of predefined steps. Toothbrush 210, similar to those described, is provided and the chemical bleaching agent employed with toothbrush 210 is applied to the teeth of a subject. Toothbrush 210 is manipulated to brush the chemical bleaching agent about the teeth and oral cavity. Bristles 218 engage the teeth, applied with the bleaching agent. Heat is transmitted from heating element 22, described with regard to FIGS. 1 and 2 and mounted with toothbrush 210, for a first predetermined duration of time, such as, for example, 30 seconds. Temperature adjacent head 216 and/or bristles 218 is regulated to control heat activation of the bleaching agent. Upon expiration of the first predetermined duration of time, transmission of heat from heating element 22 is discontinued.

Head 216 and/or bristles 218 are mechanically moved, such as, for example, by vibrating head 216 and/or bristles 218 during engagement with the teeth for a second predetermined duration of time, such as, for example, 10 seconds. Upon expiration of the second predetermined duration of time, vibration of head 216 and/or bristles 218 is discontinued.

Heat is transmitted from LEDS 222, described with regard to FIGS. 3 and 4, for a third predetermined duration of time, such as, for example, 40 seconds. Temperature adjacent head 216 and/or bristles 218 is regulated to control heat activation of the bleaching agent. Upon expiration of the third predetermined duration of time, transmission of heat from LEDS 222 is discontinued. It is contemplated that the steps of this method are separate and form a sequence that may be repeated in a continuous cycle. It is further contemplated that the sequence and/or series of steps is not limited in number, repetition or order. The steps of the method may be repeated in a predetermined number of cycles. The durations of time may be uniform.

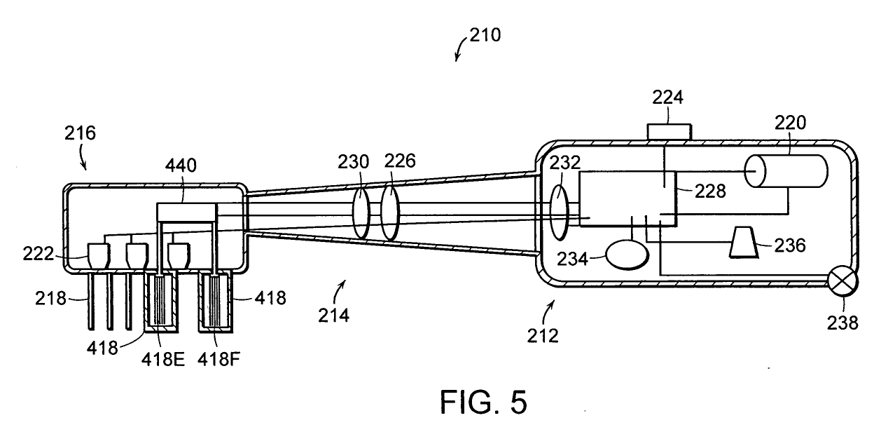

Referring to FIG. 5, another alternate embodiment of toothbrush 210, similar to that described, is shown. Head 216 includes bristles 218 and filament bristles 418 that allow for thermal conduction, via an embedded conductor of thermal energy. An embedded conductor 418E is fabricated from metal, such as a wire, or a composite material. Conductor 418E facilitates the emission of heat from the corresponding bristle 418. This configuration allows for more efficient conductivity of thermal energy or heat to the whitening agent and direct surfaces of the teeth during use. It is envisioned that toothbrush 210 may employ one or a plurality of filament bristles 418.

Head 216 also includes filament bristle 418 that has an embedded conductive element 418F that collects information regarding temperature. Conductive element 418F feeds such information back to the thermal feedback circuit of electronic circuit board 228, via a thermal sensor heat element 440, for temperature regulation of the heat activation provided by toothbrush 210.

It is contemplated that filament bristle 418 could be a hollow cylindrical tube that allows transmission of the thermal energy within hollow bristle 418 to a conductive element either within or at the proximal end thereof. This hollow bristle 418 allows detection of thermal changes at the surfaces of the teeth. It is further contemplated that fluid from within the oral cavity or water used to moisten bristles 218, 418 prior to use would become a conductor of the thermal energy at the surfaces of the teeth. It is also contemplated that the filament bristle 418 could be constructed of a polymeric material that would facilitate fiber optic transmission of a light source.

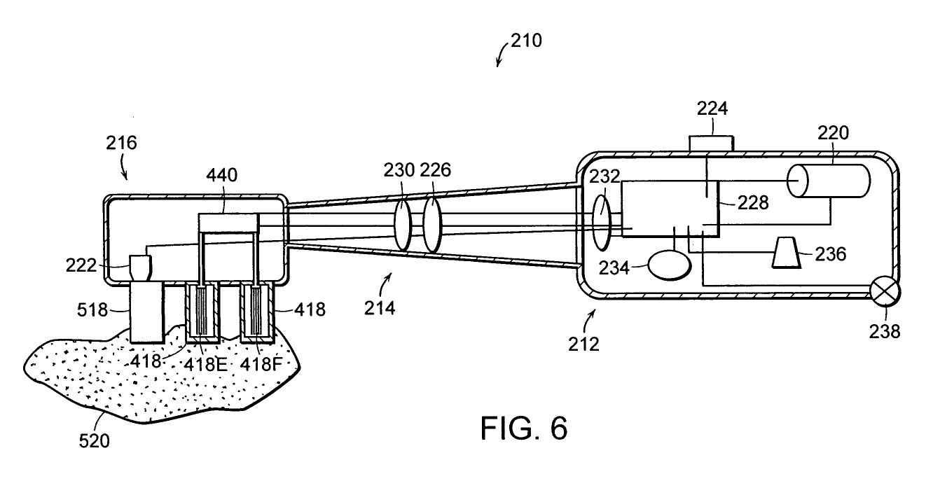

Referring to FIG. 6, another alternate embodiment of toothbrush 210, similar to that discussed with regard to FIG. 5, is shown. Toothbrush 210 has head 216 that includes bristles 418, similar to those described with regard to FIG. 5, and a fiber-optic filament bristle 518. Fiber-optic filament bristle 518 provides light emitting wave propagation that travels from LED 222 within head 216 down bristle 518 to have the light and heat energy emit therefrom directly to surfaces of the teeth to within a bleaching agent, such as a whitening gel or toothpaste.

It is contemplated that head 216 may include one or a plurality of fiber-optic filament bristles 518. The advantage to this design is to allow the heat and light energy to be directed within a whitening gel 520 for improved light penetration within the gel. This results in a more efficient and effective activation of the gel. Thus, toothbrush 210 utilizes a fiber-optic filament bristle 518 that allows heat and light energy to be emitted throughout gel 520 resulting in enhanced whitening of teeth surfaces. Direct contact of heat and light energy within the depth of gel 520 insures a uniform effect of the heat and light emitting energy throughout gel 520.

In another alternate embodiment, thermal sensor 240 may include a filament that detects temperature either within toothbrush 210 or outside toothbrush 210. The filament directs temperature data to electronic circuit board 228 and thermostat 232 to monitor and control the temperature of the heat being emitted from LEDs 222. This controller configuration of toothbrush 210 collects temperature data from thermal sensor 240 and directs temperature data to electronic circuit board 228 and thermostat 232. It is contemplated that one or a plurality of filaments may be disposed with bristles 218 to provide direct temperature sensing at the interface of contact to oral cavity surfaces such as the teeth or gums.

A dental whitening composition having teeth whitening properties is disclosed, in accordance with the principles of the present disclosures. A dental whitening composition is formed from a first gel and a second gel. The first gel is a peroxide gel having about 1 to about 15 percent peroxide by weight. In an alternative illustrative embodiment the peroxide gel can be about 35 percent peroxide by weight. The peroxide gel composition is formed by mixing approximately 3 gm of a gelling powder, Micropore Gel® powder (for example, such powder is distributed by Bioserve, San Diego, Calif.), with approximately 97 gm of deionized water. The gelling powder is mixed with the deionized water for approximately one-half hour until a clear flowable gel is formed.

The flowable gel is then mixed with approximately 10.98 gm of a 50 percent hydrogen peroxide solution and stirred slowly for approximately 15 minutes. Peralkali®, a 50% peroxide solution, (for example, such solution is distributed by Degussa Manufacturing), was used. It is contemplated that other peroxides may be used such as carbamide peroxide, potassium peroxide, calcium peroxide, or the like. A citric acid buffer is added until the mixture achieves a pH of approximately 3.5. Approximately 2 gm of a dry flavoring is added to the buffered gel composition. The formed buffered peroxide gel will stabilized to about a pH of 5 after about 24 hours.

The second gel is an accelerating gel formed by mixing approximately 3 gm of Micropore® Gel powder with approximately 97 gm of deionized water. This mixture is stirred for approximately one-half hour until a clear flowable gel is formed. The flowable gel is mixed with approximately 3.2 gm of silver ion solution (500 ppm). Approximately 10.40 gm of Tri (hydroxymethyl)-aminomethane, (for example, such solution is distributed by Angus Chemical Company, Buffalo Grove, Ill.), is added to approximately 1 gm of water forming a buffering solution. The buffering solution is added to the ionized gel solution forming the accelerating gel. The accelerating gel is contained within an opaque container until use with the peroxide gel.

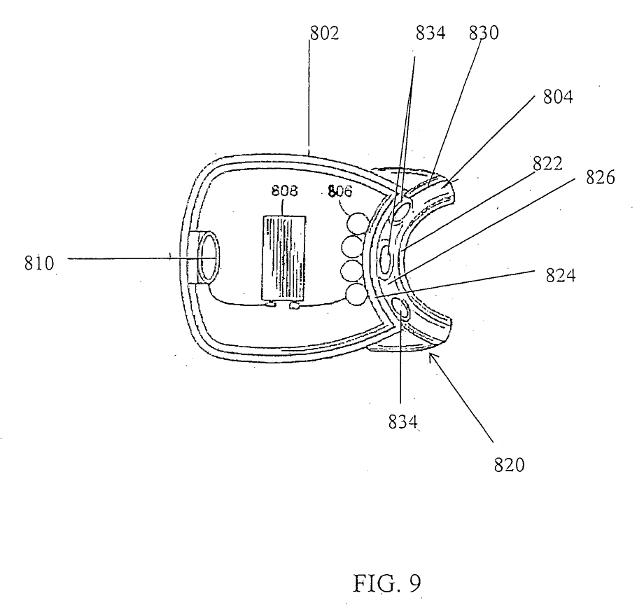

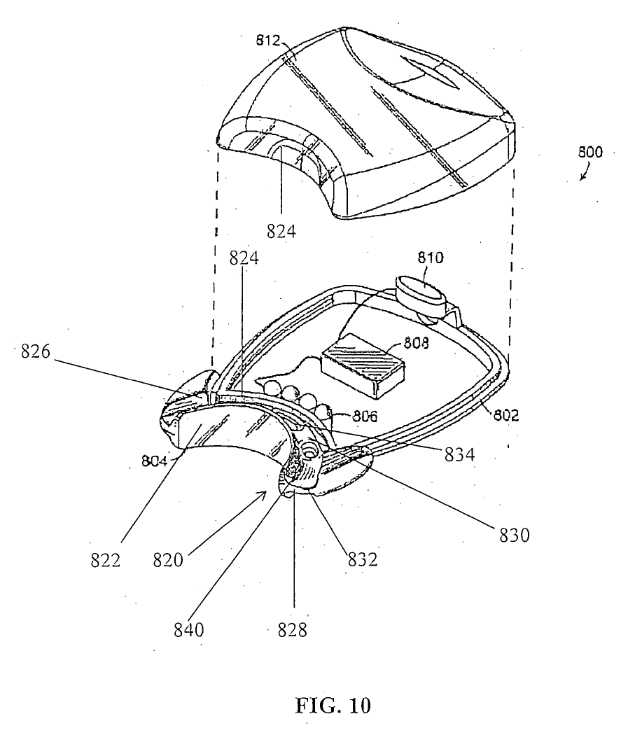

The whitening composition is formed by applying the peroxide gel to a teeth whitening apparatus, such as, for example, a dental tray 800, as described below with regard to FIGS. 9 and 10, along with the accelerating gel. The combined gels form a whitening composition that is activated by a selected light source, discussed below, within dental tray 800.

In an alternate embodiment, a metal ion accelerator is provided in a tablet formulation having a metal ion catalyst and an alkaline component. After application of the peroxide gel composition described in accordance with the present disclosure, the accelerator tablet is chewed by a patient. Transitional metal ions such as ionized silver, zinc, manganese or the like may be used as a catalyst. It is contemplated that other ions that are photo sensitive and strongly reactive to light may be used. Alkaline compounds such as sodium bicarbonate, sodium hydroxide, [tri(dydroxymethyl)aminomethane] or the like may be used to raise the pH of the whitening composition. It is contemplated that the tablets are comprised of deionized water approximately 75% by weight; ionized silver ion approximately 21% by weight; Tris Amine approximately 4% by weight; and flavoring.

In another alternate embodiment, a peroxide solution rather than a gel can be used as an oral rinse containing about 1 percent to about 15 percent hydrogen peroxide. In a further embodiment the solution can contain up to about 35 percent. It is contemplated that other peroxides may be used such as carbamide peroxide, potassium peroxide, calcium peroxide, or the like. The combination of the metal ion alkaline tablet with the peroxide rinse forms a dental composition within a patient's oral cavity having foam like consistency. This dental composition whitens the surface of the patient's teeth.

In another embodiment, an activated dental whitening composition can be formed from two solutions. The first solution contains approximately between 1 percent and 15 percent hydrogen peroxide with selected flavoring. It is contemplated within that the first solution can also contain colorants such as pigments and dyes to impart a desired color to the solution.

The second solution contains an activating silver ion solution having approximately 10 ppm to 1000 ppm of silver ion. Desirably, the second solution contains approximately 125 ppm of silver ion in about 100 gm of deionized water. The second solution is buffered by adding approximately 10.32 grams of Tri(hydroxymethyl) aminomethane added to about 1 gm of water forming a buffering solution having a pH of about 10. It is contemplated that a buffer such as Tri(hydroxymethyl) aminomethane can be used in a concentration in the second solution of about 1 percent by weight to about 15 percent by weight. This buffering solution is added to the silver ion solution along with approximately 2 gm of dry flavoring. The first solution containing the peroxide and the second solution containing the silver ion are applied to the patient's teeth by spraying each solution in a predetermined amount onto the patient's teeth. It is contemplated that these solutions can be used alone or in conjugation with the peroxide gel and accelerator gel. It is further contemplated that these solutions and gels can be used along with the accelerator tablets.

In one particular illustrative embodiment an activating silver ion solution is made by adding about 155,040 gm (155.040 kg) of de-ionized water to a mixing container. The de-ionized water is stirred and about 4,965 gm (4.965 kg) of about 500 ppm colloidal silver solution is added to the de-ionized water while being stirred at about 100 rpm until the silver solution is uniformly distributed. About 8,265 gm (8.265 kg) of Tri (hydroymethyl) aminomethane is added to the silver solution. The resulting solution is continued to be stirred at about 100 rpm until all components are uniformly distributed. The solution is then checked for a proper ph of between about 8 and about 10. After a proper ph is found, about 66.0 gm of a selected dry commercial flavoring is added to the solution and stirred at about 100 rpm for about 60 minutes thereby forming a final activating silver ion solution. The activating silver ion solution is then filled in light resistant bottles or stored at room temperature (68° F.-85° F.) in a dark light protected room until ready to use.

In further illustrative embodiment, an activating silver ion gel is made by adding about 37,040 gm (37.040 kg) of de-ionized water to a mixing container. The de-ionized water is stirred and about 3,632 gm (3.632 kg) of Micropore Gel is slowly added to the stirring de-ionized water. This mixture is stirred at 400 rpm for about 30 minutes. The resulting mixture is viscous. About 1,300 gm (1.300 kg) of about 500 ppm colloidal silver solution is added to the viscous mixture along with about 1,984 gm (1.984 kg) of Tris (hydroymethyl) aminomethane. The viscous mixture is stirred until all components are uniformly dispersed. The gel is then checked for a proper ph of between about 8 and about 10. After a proper pH is found, about 44.0 gm of a selected dry commercial flavoring is added to the gel and stirred at about 100 rpm for about 60 minutes thereby forming a final activating silver ion gel. The activating silver ion gel is then filled in light resistant bottles or stored at room temperature (68° F.-85° F.) in a dark light protected room until ready to use.

In yet a further illustrative embodiment a whitening rinse according to the disclosure is made by adding about 264,000(264.0 kg) of de-ionized water to a mixing container. The de-ionized water is stirred and about 66,000 gm (66.0 kg) of about 35% hydrogen peroxide solution is added to the de-ionized water forming a hydrogen peroxide solution. About 132 gm of a selected dry commercial flavoring is added to the hydrogen peroxide solution and stirred at about 100 rpm for about 60 minutes thereby forming a whitening rinse.

The light source has a wavelength selected that is specific to the photo-sensitive metal ion within the dental whitening composition, similar to the compositions described above, may be used to activate the dental whitening composition by increasing the decomposition of the peroxide used. This decomposition allows for a hastening of the whitening effect and a dramatic decrease in contact time. The light source, such as, for example, a light bulb or LED producing wavelengths forming blue, cyan, amber or white light can be used to activate the photo ions. It is contemplated that the desired selected light wavelength can be produced by a bulb or LED selected or by the use of an optical wavelength filter allowing for the selection of a desired wavelength range.

For example, a LED, (as distributed by Nichia Corporation, of Japan, part number, NSPB 320a), is employed producing a wavelength within the range of about 430 nm to about 490 nm. It is contemplated that the LED used in this illustrative embodiment has the following specifications: Chromaticity Coordinate Typical (x,y) 0.130 to 0.75; Luminous intensity (mcd) 3900; Forward Voltage 3.5 max 4.0; Direction Characteristics 30 degrees Size 3.0 mm.

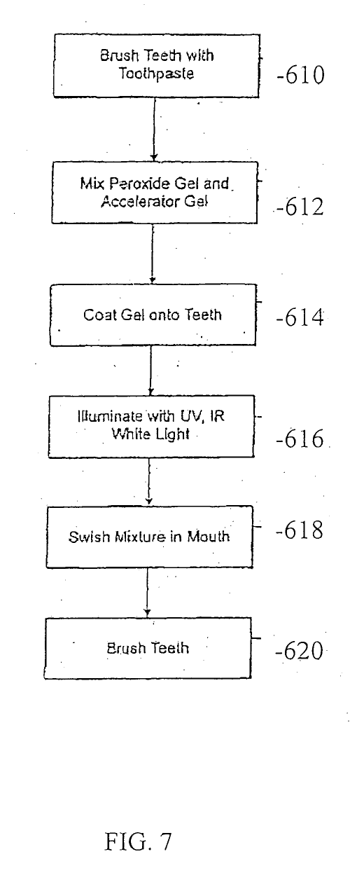

Referring to FIG. 7, the dental whitening composition, similar to the compositions described above, is employed in a teeth whitening procedure that includes brushing a patient's teeth (step 610). The dental whitening composition is formed from a peroxide gel and an accelerator gel forming an activated gelling agent (step 612). The activated gelling agent is then coated onto the teeth and added to a dental receiving area 804, discussed below with regard to FIGS. 9 and 10, of dental tray 800 before the patient inserts dental tray 800 into their mouth and illuminates the surfaces of their teeth with the light source embedded into dental tray 800. (step 614). The teeth of the patient are disposed within dental receiving area 804. The light source illuminates the coated teeth for approximately two minutes (step 616). The activated gelling agent mixture is swished about the patient's mouth after illumination (step 618). The patient's teeth are brushed (step 620). Alternatively, steps 612, 614 may include mixing the ingredients of the dental whitening composition in dental receiving area 804. For example, the peroxide gel and accelerator gel are separately disposed within dental receiving area 804. The peroxide gel and the accelerator gel mix to form the activated gelling agent. The patient then inserts dental tray 800 within their mouth and illuminates the surface of their teeth with the light source embedded in dental tray 800. The teeth of the patient are disposed within dental receiving area 804. The patient's teeth may or may not be pre-coated prior to insertion of dental tray 800 within the patient's mouth.

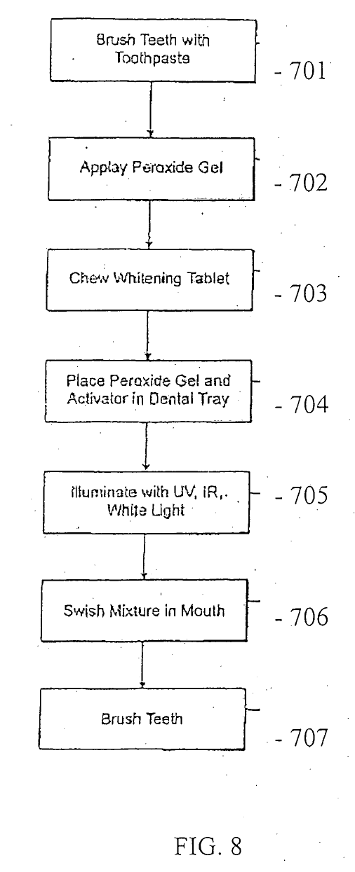

Referring to FIG. 8, the dental whitening composition, similar to the compositions described above, is employed in a teeth whitening procedure that includes brushing the patient's teeth (step 701) and placing a peroxide gel onto the patient's teeth surfaces (step 702). The patient then chews an activator tablet (step 703) forming a whitening composition. The patient then places peroxide gel into dental receiving area 804 along with the activator gel (step 704), which is placed on top of the peroxide gel. The resulting whitening composition is illuminated for approximately two minutes or more (step 705). The illuminated composition is then swished around the oral cavity for as long as desired (step 706). The oral cavity is rinsed and the patient brushes their teeth (step 707).

The light source can be embedded in a dental tray 800 or be in optical communication with dental tray 800. As shown in FIGS. 9 and 10, dental tray 800 has a top plate 812 and a bottom plate 802. Top plate 812 and bottom plate 802 are connected with a mouthpiece 820 of dental tray 800. Mouthpiece 820 is mounted with plates 812, 802 to form dental tray 800. It is contemplated that mouthpiece 820 may be molded with, adhered to, mechanically fixed, etc., to plates 812, 802, although other types of manufacture are envisioned, as is known to one skilled in the art.

Mouthpiece 820 includes a dental receiving area 804, which is configured to be contoured to a patient's teeth. Dental receiving area 804 includes a first wall 822 and a second wall 824 that define cavities 826, 828. First wall 822 is configured for disposal within the oral cavity and adjacent the inner or back surfaces of a patient's teeth. Second wall 824 is configured for disposal adjacent the outer or front surfaces of a patient's teeth.

Second wall 824 is formed of mouthpiece 820 and back plate 802. It is contemplated that second wall 824 may be formed from only mouthpiece 820, or alternatively, only back plate 802. Walls 822, 824 have optical properties in a configuration to allow the transmission and emittance of radiation or light to all surfaces of dental receiving area 804 and the patient's teeth. For example, walls 822, 824 can be fabricated from a polymeric composition that is transparent to a selected wavelength range for a light source, such as the light source disposed with dental tray 800.

Dental receiving area 804 includes a first compartment, such as, for example, an upper compartment 830 and a second compartment, such as, for example, a lower compartment 832. Upper compartment 830 includes cavity 826 and lower compartment 832 includes cavity 828, as defined by walls 822, 824. Cavities 826, 828 are configured for disposal of a dental whitening composition, as well as facilitating mixing of the ingredients of the composition and/or other compositions, medications, as described above. A biteplane wall 840 extends between walls 822, 824. Biteplane wall 840 separates upper compartment 830 and a lower compartment 832.

Dental receiving area 804 includes openings 834 defined by biteplane wall 840, which are configured for disposal in the occlusal biteplane of a patient's oral cavity. Openings 834 are configured to facilitate mixing of the ingredients of a composition from cavity 826 of upper compartment 830 to cavity 828 of lower compartment 832. It is envisioned that openings 834 may serve as a reservoir for a composition during application thereof to a patient's teeth. It is contemplated that dental receiving area 804 provides a medium for transmission of energy from the light source to the patient's teeth. Dental receiving area 804 also facilitates distribution of a composition to a patient's teeth.

Walls 822, 824 of dental receiving area 804 are formed in the shape of orthodontic wire and the curvature of a patient's teeth. Dental receiving area 804 is loose fitting formed of a pliable material allowing both sides of the teeth to receive the dental whitening compositions, such as a gel or rinse material, as well as medications and other compositions.

Bottom plate 802 is formed from a rigid polymeric material. Dental receiving area 804 is formed from a pliable polymeric material and is fixably attached to bottom plate 802. Dental receiving area 804 is formed from a pliable silicone that is transparent to the wavelength range of a light source attached to bottom plate 802. It is contemplated dental receiving area 804 can be fabricated from any polymeric compound that is pliable and translucent to a selected wavelength range. It is further contemplated that the polymeric composition forming dental receiving area 804 has light transmitting properties allowing dental receiving area 804 to act as a fiber optic bundle transmitting light to all areas of dental receiving area 804.

Bottom plate 802 is equipped with at least one light source, such as, for example, LED 806 that produces a light having a selected wavelength. As shown in FIGS. 9 and 10, a plurality of LEDs 806 are mounted in bottom plate 802 so that their emitted light is directed around the curvature of dental receiving area 804. It is contemplated that focusing optics or filtering optics can be mounted in front of the light emitting portion of LEDs 806. These optics can direct the emitted light or filter the emitted light to a desired wavelength range. It is also contemplated within the scope of the disclosure that a singular LED or light source can be positioned in optical communication with a fiber optic bundle that delivers the emitted light from the light source to desired locations within dental receiving area 804.

LEDs 806 are powered by a battery pack 808 that is in electrical communication with each LED 806. Battery pack 808 is a standard 9 volt battery, although other battery and power supply configurations are envisioned. It is contemplated that a rechargeable battery or batteries may be used that produce the needed electrical power specifications for LED 806 or other light source used. It is also contemplated that LEDs 806 can be powered by standard household electricity using a transformer capable of providing the desired voltage or recharging rechargeable batteries. The electrical communication of LEDs 806 is controlled by a single pole electrical switch 810 allowing a user to power on and off LEDs 806. An electrical resistant element (not shown) is incorporated into the electrical circuit allowing dental tray 800 to warm to approximately 100° Fahrenheit. It is contemplated that electrical switch 810 may further contain a timer element allowing the user to select a desired operational time and alternatively a pre-selected operational time.

Battery pack 808, the electrical communication to LEDs 806 and electrical switch 810 are protected from the dental compositions utilized and outside elements by the use of cover plate 812 that is removably attached to bottom plate 802. Cover plate 812 is formed from a polymeric material such as ABS, polycarbonate, or the like. It is contemplated bottom plate 802 and cover plate 812 can be fabricated from various metals. It is further contemplated that plate 812, 802 may be integrally connected or monolithically formed as a one piece unit of dental tray 800.

In another alternate embodiment employing dental tray 800, similar to those discussed above, a two-part whitening composition is used that is formed from a first gel and a second gel. The first gel is a hydrogen peroxide gel having about 7.0 percent peroxide by weight. It is contemplated within the scope of this disclosure that the first gel may have up to about 35.0 percent hydrogen peroxide by weight. A citric acid buffer and a dry flavoring are added to the gel composition. The second gel is an accelerating gel formed by mixing Micropore® gel powder with deionized water. Silver ion solution and trisamine flavoring are added to the second gel. The two-part whitening composition is formed by applying the peroxide gel to cavity 826 and/or cavity 828 of dental receiving area 804 along with the accelerating gel, which causes decomposition of the hydrogen peroxide in the whitening composition. The combined gels form a whitening composition that is further activated by LEDs 806, as discussed.

LEDs 806 have a wavelength range selected that is specific to the photo-sensitive silver ion within the dental whitening composition and is used to activate the dental whitening composition by increasing the decomposition of the peroxide used. This decomposition allows for a hastening of the whitening effect and a dramatic decrease in contact time.

In use, the tip of a whitening gel tube is cut off and its gel contents are dispensed onto the center of dental receiving area 804. The gel is added to upper compartment 830 of dental receiving area 804. The gel flows from upper compartment 830 through openings 834 to lower compartment 832. The whitening gel consists of water, hydrogen peroxide, Micropore® gel, citric acid and flavoring, similar to that described.

The tip of the whitening gel accelerator tube is cut off and its gel contents are dispersed onto the center of dental receiving area 804. The whitening gel accelerator consists of water, Micropore® gel, trisamine, flavoring and silver ion. Upon mixing of the whitening gel and the whitening gel accelerator, the whitening gel accelerator immediately causes decomposition of the hydrogen peroxide in the whitening gel.

Dental tray 800 is placed in a subject's mouth and LEDs 806 are turned on. The light automatically turns off in approximately 2 minutes. Dental tray 800 is removed from the subject's mouth. The remaining gel in the subject's mouth is swished about for 5-7 minutes and then rinsed from the subject's mouth with water. The steps may be repeated.

Although the illustrative embodiments show the use of metal ions within the activating solution, gel or tablet, it will be understood by those skilled in the art that ions other than metal ions may be used to accelerate the breakdown of peroxides during the bleaching process. Likewise it will also be understood that ions that are highly sensitive to heat may be used to accelerate the breakdown of peroxides during the bleaching process.

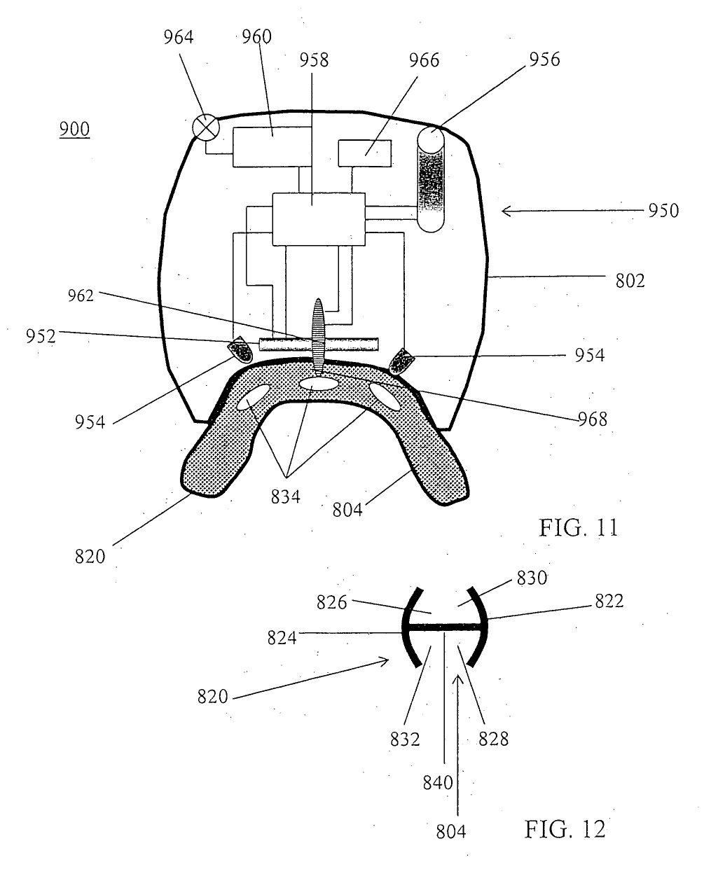

Referring to FIGS. 11 and 12, an alternate embodiment of the dental whitening apparatus, a dental tray 900 is shown, similar to dental tray 800 discussed with regard to FIGS. 9 and 10. Dental tray 900 includes a body, such as, for example, handle 950, which has cover plate 812 (not shown) and bottom plate 802 described above. Handle 950 includes a heating element 952 and a light emitting device, such as, for example, light emitting diodes (LEDs) 954, similar to the LEDs described above with regard to FIGS. 7-10. Heating element 952 and LEDs 954 are disposed for activating a bleaching composition, similar to those discussed herein.

Dental tray 900 includes mouthpiece 820, described above with regard to FIGS. 9 and 10, mounted with handle 950. Mouthpiece 820 includes dental receiving area 804 that is formed of a polymeric composition that facilitates transmission and emittance of light to activate the dental whitening composition by increasing the decomposition of, for example, a peroxide being used with the composition. Dental receiving area 804 is contoured to a set of teeth of a subject (not shown). As discussed above, dental receiving area 804 has a first wall 822, a second wall 824, and a biteplane wall 840 extending therebetween. Biteplane wall 840 includes a plurality of openings 834 and separates upper compartment 830 and lower compartment 832. First wall 822 and second wall 824 define a first cavity 826 of upper compartment 830 and a second cavity 828 of lower compartment 832.

Cavities 826, 828 are configured for disposal of the bleaching composition. Cavities 826, 828 communicate via openings 834. It is contemplated that the bleaching composition includes at least two separate ingredients that are mixed in cavities 826, 828, although one or a plurality of ingredients are envisioned. It is further contemplated that a medication is disposed within cavities 826, 828 and mixed with the composition, although a plurality of medications are envisioned. The composition may include various medications such as, for example, fluorides, anti-microbial agents, anesthetics, analgesics and desensitizing agents.

An energy source 956 is disposed within handle 950 for providing an energy source for heating element 952. It is contemplated that energy source 956 may include alternate sources of energy, such as, for example, an A/C power source, rechargeable batteries, replaceable batteries, etc. It is also contemplated that a sealed single-use battery may provide the energy source to heating element 952. Energy source 956 is connected to an electronic circuit board 958, disposed within handle 950, for operating dental tray 900, as will be discussed. An on/off switch 960 is disposed on handle 950 for connection with electronic circuit board 958 and an on/off indicator (not shown) may be included on the surface of handle 950, such as a LED, bulb, etc. to provide visual indicia of the on/off status of dental tray 900.

Dental tray 900 is employed for the cosmetic whitening of teeth (not shown) through thermal and light emitted chemical activation processes. Dental tray 900 activates a chemical bleaching composition through controlled light and heat activation, which can be temperature regulated, as described herein. On/off switch 960 is manipulated to turn dental tray 900 on.

On/off switch 960, via electronic circuit board 958, enables powering of heating element 952 from energy source 956. Visual indicia and/or audible indicia can be provided to alert the user to the on/off status of heating element 952. An on/off indicator (not shown) may be included, which is connected to electronic circuit board 958, to indicate that heating element 952 is transmitting heat energy.

Heating element 952 is disposed with handle 950 in an orientation to transmit heat energy adjacent dental receiving area 804. Heating element 952 is configured to transmit heat energy adjacent dental receiving area 804 to the bleaching composition disposed within cavities 826, 828 and on a subject's teeth, to activate the bleaching composition for cosmetic whitening of the subject's teeth. The temperature or range of temperature can be maintained by use of electronic circuit board 958, which is connected to a thermostat 962 with a feed-back loop circuit of board 958. It is envisioned that thermostat 962 includes a temperature sensor disposed adjacent dental receiving area 804 for monitoring temperature, including the temperature of the composition disposed within cavities 826, 828. This configuration is employed to monitor and control the temperature adjacent dental receiving area 804 according to the heat being emitted from heating element 952. Thermostat 962 is pre-set such that the upper limit and lower limit of the temperature can be controlled. It is contemplated that a single range of temperature is pre-set for use or that the user would be able to adjust the range of temperature. It is also contemplated that a single temperature could be adjusted. It is envisioned that various temperature sensors may be used that are suitable for dental applications, such as, for example, thermistor, thermocouple, RTDs, infrared, fiber optic, microchip, or the like.

Electronic circuit board 958 is connected to a thermal sensor 968 that is disposed adjacent dental receiving area 804. Thermal sensor 968 detects temperature data adjacent dental receiving area 804 including the composition disposed in cavities 826, 828, and sends the temperature data to electronic circuit board 968 and thermostat 962 to monitor and control the temperature of the heat being emitted from heating element 952. Thermal sensor 968 provides continuous feedback to electronic circuit board 958 and thermostat 962 to monitor and control temperature to regulate the process of whitening. It is contemplated that thermal sensor 968 may be disposed at various positions adjacent dental receiving area 804. It is further contemplated that thermal sensor 968 may be separate or integrated with heating element 952. Thermal sensor 968 can be disposed within dental tray 900 or external to dental tray 900.

Electronic circuit board 958 and the related circuitry of dental tray 900 may employ those components known to one skilled in the art that are suitable for a dental application. It is envisioned that dental tray 900 may include a processor, printed circuit board or microprocessor components that operate and control the components of dental tray 900, suitable for teeth whitening applications.

A rheostat temperature control 964, connected with electronic circuit board 958, regulates the temperature in a specified range to control transmission of heat energy and corresponding heat activation of the chemical bleaching composition. Rheostat temperature control 964 has a manipulable dial configuration regulating temperature in a defined temperature range. It is contemplated that control 964 may regulate temperature in a temperature range of 70°-140° F. Rheostat temperature control 964 can be manipulated or rotated to a desired temperature. Rheostat temperature control 964 can be set to pre-defined levels such as, for example, low, medium, high. Alternatively, rheostat temperature control 964 may regulate other numerically defined temperature ranges.

An internal timer 966, connected with electronic circuit board 958, controls the duration of heat energy transmitted from heating element 952 to allow heat activation for a specific amount of time. The length of time can be adjusted according to the particular application. It is contemplated that visual indicia may be employed for monitoring internal timer 966, such as digital, analog, etc.

In operation of heating element 952, thermostat 962 sets a predefined temperature range for heating element 22 for heat activation of a chemical bleaching composition. Heating element 952 generates heat energy corresponding to the preset temperature range. Thermal sensor 968 detects temperature data adjacent dental receiving area 804, including the composition disposed in cavities 826, 828 and on the subject's teeth, and sends the temperature data to electronic circuit board 958 and thermostat 952 to monitor and control the temperature adjacent dental receiving area 804 according to the heat being emitted from heating element 952. The thermal data from thermal sensor 968 provides the data such that electronic circuit board 958 and thermostat 962 can regulate the temperature to the defined range set by thermostat 962. These elements control a specific range of temperature at the point of application, including the composition disposed in cavities 826, 828 and on the subject's teeth, thereby detecting temperature that is external to electronic circuit board 958 to be used to control the system.

Alternatively, the temperature regulated heat emission of dental tray 900 for heat activation of the chemical bleaching composition can facilitate a phase change of the composition or agent. For example, the emission of heat from heating element 952 may cause a phase change of the composition, such as from a higher viscosity gel to a liquid of a lower viscosity. This phase change to a lower viscosity more readily distributes the composition about the subject's teeth. This distribution provides for a greater coverage of teeth and lower amount of agent being used.

Energy source 956 also provides an energy source for LEDs 954. On/off switch 960, via electronic circuit board 958, also enables powering of LEDs 954. Visual indicia and/or audible indicia can be provided that alerts the user to the on/off status of LEDs 954. LEDs 954 are disposed in an orientation to emit visible light to dental receiving area 804 adjacent (within any range of wavelength that chemically activates the bleaching composition). LEDs 954 transmit light energy adjacent dental receiving area 804, which facilitates transmission and emittance of light energy from LEDs 954 to the composition disposed in cavities 826, 828 and on the subject's teeth to activate the chemical bleaching composition by increasing the decomposition of, for example, a peroxide being used with the composition for cosmetic whitening of a patient's teeth.

Internal timer 966, connected with electronic circuit board 958, controls the duration of light energy being transmitted from LEDs 954 to allow light activation for a specific amount of time. The length of time can be adjusted according to the particular application.

It is contemplated that use of heat and light, via heating element 952 and LEDs 954, for activation of the composition disposed in cavities 826, 828 represents a two phase activation cycle. For example, heating element 952 emits heat, as described, in a first phase that employs heat to cause the molecules of the whitening composition or compound to become excited and reactive for teeth whitening applications. In a second phase, the light emitted from LED 954 causes a further and separate excitation and reaction of the compound molecules for teeth whitening. Thus, dental tray 900 employs a first phase of heat emission and a second phase of light emission for separate chemical reactions in a single teeth whitening application. This two phase activation cycle may include vibratory action, as discussed herein.

In a teeth whitening application, dental tray 900, described above with regard to FIGS. 11 and 12, is employed with a subject (not shown) having a set of teeth. A first ingredient, such as, for example, a peroxide of the bleaching composition is disposed within cavity 826 and/or cavity 828 of dental receiving area 804. A second ingredient, separate from the first ingredient, such as, for example, an accelerating agent of the bleaching composition is disposed within cavity 826 and/or cavity 828 with the first ingredient.

The first ingredient and the second ingredient are mixed within cavity 826 and/or cavity 828 to form the bleaching composition. The first ingredient and the second ingredient also pass through openings 834 to facilitate mixing of the composition. It is contemplated that the composition may be mixed independently in either cavity 826 or cavity 828, or, alternatively, mixed solely in cavity 826 or solely in cavity 828. It is further contemplated that the first ingredient and the second ingredient may be mixed independently in compartments 830, 832, whereby biteplane wall 840 does not include openings 834, as shown in FIG. 20. It is envisioned that a medication, as discussed above, may be mixed with the composition in cavity 826 and/or cavity 828. Desirably, such medication is disposed with the composition prior to mixing.

Dental tray 900 is placed in a subject's mouth such that the set of teeth are disposed within cavities 826, 828 such that the bleaching composition engages the set of teeth. The upper teeth are disposed in the upper compartment 830 and the lower teeth are disposed in the lower compartment 832. Heat energy is transmitted from heating element 952 and light energy is transmitted from LEDs 954 to the bleaching composition disposed in cavities 826, 828 and coating the set of teeth for activating the bleaching composition, as discussed above. It is contemplated that the ingredients, medications, etc. are mixed with dental receiving area 804 prior to placement of dental tray 900 in the subject's mouth.

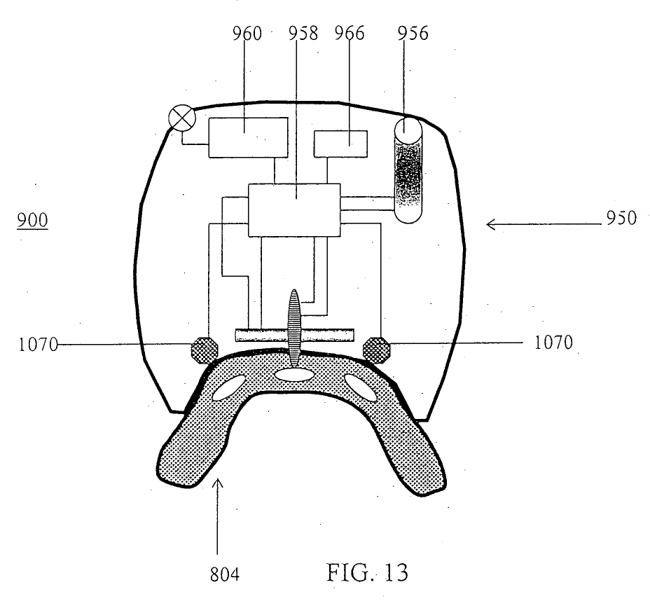

Referring to FIG. 13, in an alternate embodiment, similar to that described with regard to FIGS. 11 and 12, handle 950 of dental tray 900 further includes a vibratory element, such as, for example, ultrasonic elements 1070. Ultrasonic elements 1070 are disposed in a configuration for mixing the bleaching composition and/or medication disposed in cavity 826 and/or cavity 828 (shown in FIG. 12) of dental receiving area 804.

Energy source 956 also provides an energy source for ultrasonic elements 1070. On/off switch 960, via electronic circuit board 958, also enables powering of ultrasonic elements 1070. Visual indicia and/or audible indicia can be provided that alerts the user to the on/off status of ultrasonic elements 1070. Internal timer 966 controls the duration of vibratory energy being transmitted from ultrasonic elements 1070 to allow vibratory mixing of the composition disposed within cavity 826 and/or cavity 828 for a specific amount of time. The length of time can be adjusted according to the particular application. It is contemplated that the vibratory energy is transmitted from ultrasonic elements 1070 in a series of bursts, which may be separated by set or random time intervals.

In use, ultrasonic elements 1070 are activated to transmit energy to vibrate dental receiving area 804. Vibration of dental receiving area 804 causes the first ingredient and the second ingredient to be mixed within cavity 826 and/or cavity 828 to form the bleaching composition. This configuration advantageously provides a more expeditious manner to mix the ingredients of the composition, including medications, and distribute the bleaching composition, medication, etc. effectively about and in between the teeth and gums of the subject. For example, ultrasonic elements 1070 can be activated to create a cavitation effect with the composition causing distribution about and in between the teeth and gums. It is contemplated that ultrasonic elements 1070 may produce mechanical and heat energy. It is further contemplated that ultrasonic elements 1070 may include ultrasonic transducers, including piezoelectric vibrator elements, such as, piezoelectric ceramics, which operate at a selected frequency suitable for radiating energy in a dental application. Resonators, magnorestrictive vibrators, etc. may also be included. It is envisioned that ultrasonic elements 1070 may generate vibrations of ultrasonic frequency in the range of 20-80 kHZ.

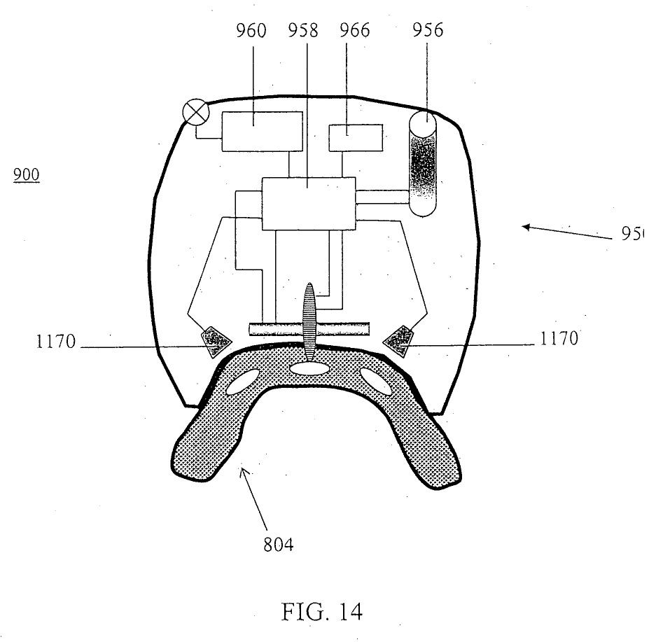

Referring to FIG. 14, in an alternate embodiment, similar to that described with regard to FIG. 13, handle 950 of dental tray 900 further includes a vibratory element, such as, for example, acoustic elements 1170. Acoustic elements 1170 are disposed in a configuration for mixing the bleaching composition and/or medication disposed in cavity 826 and/or cavity 828 (shown in FIG. 12) of dental receiving area 804.

Energy source 956 also provides an energy source for acoustic elements 1170. On/off switch 960, via electronic circuit board 958, also enables powering of acoustic elements 1170. Visual indicia and/or audible indicia can be provided that alerts the user to the on/off status of acoustic elements 1170. Internal timer 966 controls the duration of acoustic energy in the form of sonic waves at a selected frequency being transmitted from acoustic elements 1170 to dental receiving area 804 to allow vibratory mixing of the composition disposed within cavity 826 and/or cavity 828 for a specific amount of time. It is contemplated that a sonic vibration frequency in the range of 20 Hz to 400 Hz may be employed. The length of time can be adjusted according to the particular application. A sonic power generator may be employed with acoustic elements 1170 to provide a random vibrating direction, or a selective direction control may be used. It is envisioned that sonic power can be generated using electric motors, oscillating solenoids and vibrating piezoelectric devices. It is further envisioned that the vibratory energy is transmitted from acoustic elements 1170 in a series of bursts, which may be separated by time intervals.

In use, acoustic elements 1170 are activated to transmit sonic waves at a selected frequency from acoustic elements 1170 to dental receiving area 804 to vibrate dental receiving area 804. Vibration of dental receiving area 804 causes the first ingredient and the second ingredient to be mixed within cavity 826 and/or cavity 828 to form the bleaching composition. This configuration advantageously provides a more expeditious manner to mix the ingredients of the composition, including medications, and distribute the bleaching composition, medication, etc. effectively about and in between the teeth and gums of the subject. For example, acoustic elements 1170 can be activated to create a cavitation effect with the composition causing distribution about and in between the teeth and gums.

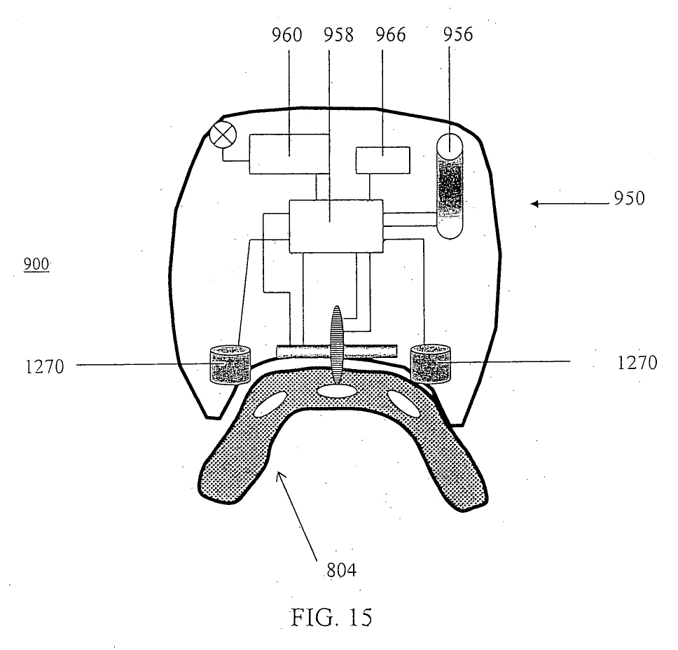

Referring to FIG. 15, in an alternate embodiment, similar to that described with regard to FIG. 13, handle 950 of dental tray 900 further includes vibratory elements 1270. Vibratory elements 1270 are disposed in a configuration for mixing the bleaching composition and/or medication disposed in cavity 826 and/or cavity 828 (shown in FIG. 12) of dental receiving area 804.

Energy source 956 also provides an energy source for vibratory elements 1270. On/off switch 960, via electronic circuit board 958, also enables powering of vibratory elements 1270. Visual indicia and/or audible indicia can be provided that alerts the user to the on/off status of vibratory elements 1270. Internal timer 966 controls the duration of vibratory energy being transmitted from vibratory elements 1270 to allow vibratory mixing of the composition disposed within cavity 826 and/or cavity 828 for a specific amount of time. The length of time can be adjusted according to the particular application. It is contemplated that the vibratory energy is transmitted from vibratory elements 1270 in a series of bursts, which may be separated by time intervals.

In use, vibratory elements 1270 are activated to transmit mechanical energy to vibrate dental receiving area 804. Vibration of dental receiving area 804 causes the first ingredient and the second ingredient to be mixed within cavity 826 and/or cavity 828 to form the bleaching composition. This configuration advantageously provides a more expeditious manner to mix the ingredients of the composition, including medications, and distribute the bleaching composition, medication, etc. effectively about and in between the teeth and gums of the subject. For example, vibratory elements 1270 can be activated to create a cavitation effect with the composition causing distribution about and in between the teeth and gums. It is contemplated that vibratory elements 1270 may include transducers, including piezoelectric elements, suitable for a dental application.

One or all of the vibratory elements, ultrasonic elements 1070, acoustic elements 1170, and vibratory elements 1270, can also be activated to clean the subject's teeth including removal of food particles, bacteria buildup and plaque, as well as other tooth surfaces. Dental receiving area 804 is disposed with the oral cavity of a subject and the composition disposed with cavities 826 and/or 828 is agitated via the transmission of vibratory energy discussed above. Agitation of the composition causes cavitation of the composition, which distributes the composition about and in between the teeth and gums for cleansing. This advantageous configuration for cleansing of the teeth and gums can significantly decrease the possibility of tooth decay. It is contemplated that the composition may include various cleansing agents, toothpaste, medication, etc.

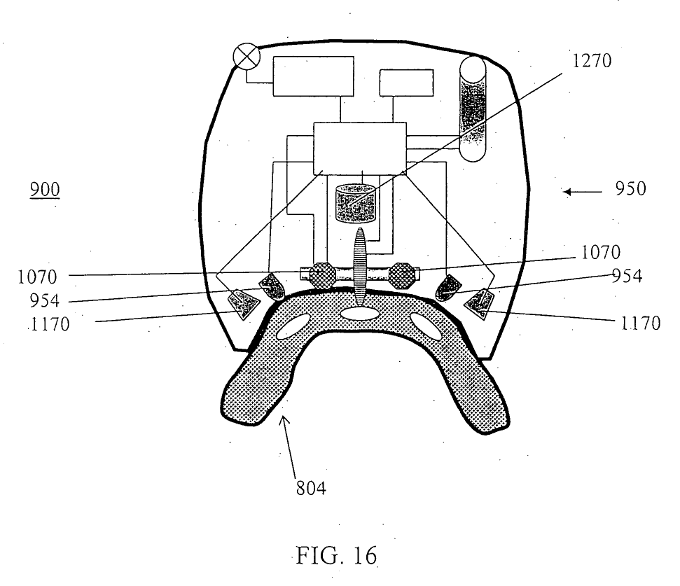

Referring to FIG. 16, in an alternate embodiment, similar to that described with regard to FIGS. 11-15, handle 950 of dental tray 900 includes LEDs 954, ultrasonic elements 1070, acoustic elements 1170 and a vibratory element 1270 described above. In one particular use for teeth whitening, dental tray 900 is employed with a cycling and sequence application, which includes a series of predefined steps. Dental tray 900 is provided with the ingredients for a composition, as described in methods above.

One or all of the vibratory elements, ultrasonic elements 1070, acoustic elements 1170 and a vibratory element 1270, can be activated for a predetermined time period to facilitate mixing of the composition disposed in cavity 826 and/or cavity 828. Dental tray 900 is placed in a subject's mouth such that the set of teeth are disposed within cavities 826, 828 such that the bleaching composition engages the set of teeth. The upper teeth are disposed in the upper compartment 830 and the lower teeth are disposed in the lower compartment 832.

Heat is transmitted from heating element 952 for a first predetermined duration of time, such as, for example, 30 seconds. Temperature adjacent dental receiving area 804 is regulated to control heat activation of the bleaching composition. Upon expiration of the first predetermined duration of time, transmission of heat from heating element 952 is discontinued.

One or all of the vibratory elements, ultrasonic elements 1070, acoustic elements 1170 and a vibratory element 1270, are activated for a second predetermined duration of time, such as, for example, 30 seconds to further facilitate mixing of the composition disposed in cavity 826 and/or cavity 828. Upon expiration of the second predetermined duration of time, transmission of energy from the vibratory elements is discontinued.

Light is transmitted from LEDs 954, as described above, for a third predetermined duration of time, such as, for example, 40 seconds. Upon expiration of the third predetermined duration of time, transmission of light from LEDs 954 is discontinued. It is contemplated that the steps of this method are separate and form a sequence that may be repeated in a continuous cycle. It is further contemplated that the sequence and/or series of steps is not limited in number, repetition or order. The steps of the method may be repeated in a predetermined number of cycles. The durations of time may be uniform.

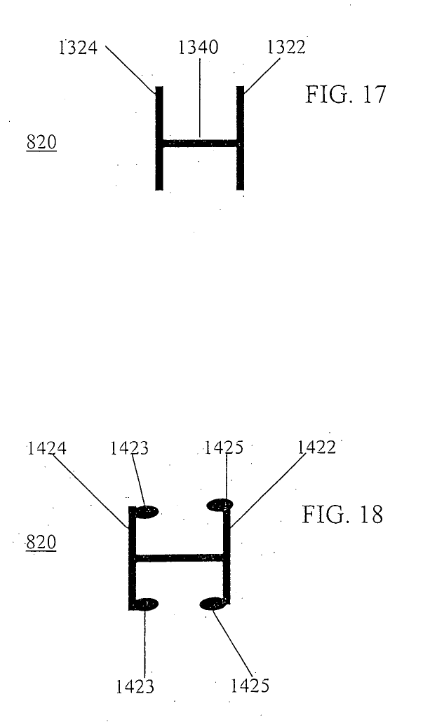

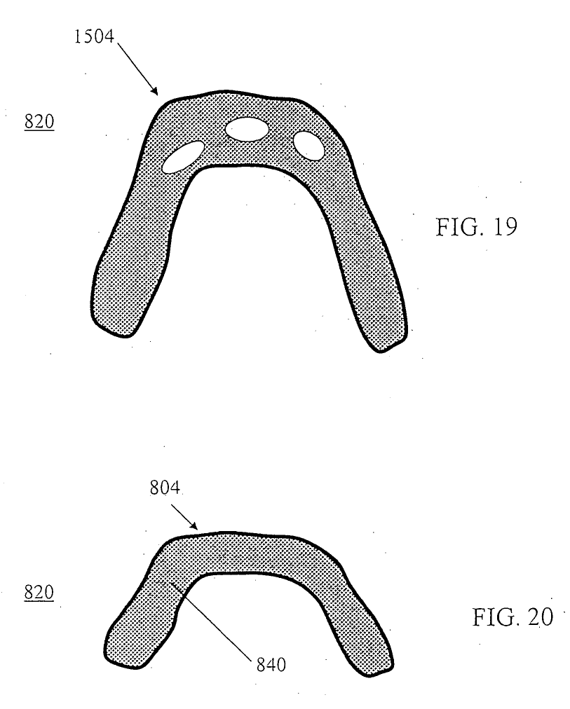

Referring to FIG. 17, in an alternate embodiment of dental tray 900 described above, mouthpiece 820 includes a biteplane wall 1340 that is disposed in a perpendicular orientation relative to a first wall 1322 and a second wall 1324. In another alternate embodiment of dental tray 900 described above, as shown in FIG. 18, mouthpiece 820 includes a first wall 1422 having rounded edges 1423 and a second wall 1424 having rounded edges 1425. Edges 1423, 1425 provide comfort to the subject and facilitate placement of dental tray 900 in a subject's oral cavity. In another alternate embodiment of dental tray 900 described above, as shown in FIG. 19, mouthpiece 820 includes a dental receiving area 1504 that is contoured to a subject's set of teeth in a full arch configuration.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A dental whitening apparatus comprising:
a body including a heating element and a light emitting device, the heating element and the light emitting device being disposed for activating a bleaching composition; and
a mouthpiece connected with the body, the mouthpiece including a dental receiving area being formed of a material that facilitates transmission and emittance of light, and being contoured to a set of teeth, the dental receiving area having a first wall and a second wall that define a cavity,
wherein the cavity is configured for disposal of the bleaching composition.

2. A dental whitening apparatus as recited in claim 1, further comprising a thermal sensor being disposed adjacent the dental receiving area and configured to sense temperature of the bleaching composition, wherein a temperature of the bleaching composition is regulated by a thermal feedback circuit communicating with the thermal sensor and a thermostat disposed with the body to control heat activation of the bleaching composition.

3. A dental whitening apparatus as recited in claim 1, wherein the bleaching composition includes at least two separate ingredients that are mixed in the cavity of the dental receiving area.

4. A dental whitening apparatus as recited in claim 1, further comprising at least one medication being disposed in the cavity of the dental receiving area.

5. A dental whitening apparatus as recited in claim 1, wherein at least one medication is selected from the group consisting of fluoride, anti-microbial agent, anesthetic, and desensitizing agent.

6. A dental whitening apparatus as recited in claim 1, wherein the body further includes a vibratory element disposed in a configuration for mixing the bleaching composition disposed in the cavity of the dental receiving area.

7. A dental whitening apparatus as recited in claim 1, wherein the vibratory element includes an ultrasonic energy element disposed in a configuration for mixing the bleaching composition disposed in the cavity of the dental receiving area.

8. A dental whitening apparatus as recited in claim 1, wherein the vibratory element includes an acoustic element disposed in a configuration for mixing the bleaching composition disposed in the cavity of the dental receiving area.

9. A dental whitening apparatus as recited in claim 1, wherein the cavity supports the bleaching composition in a configuration such that the bleaching composition is a medium for transmission of heat energy from the heating element and light energy from the light emitting device to the set of teeth.

10. A dental whitening apparatus as recited in claim 1, wherein the dental receiving area includes a biteplane wall that extends between the first wall and the second wall.

11. A dental whitening apparatus as recited in claim 10, wherein the biteplane wall includes at least one opening.

12. A dental whitening apparatus as recited in claim 10, wherein the biteplane wall contains a plurality of openings.

13. A dental whitening apparatus as recited in claim 10, wherein the biteplane wall separates a first compartment and a second compartment of the dental receiving area.

14. A dental whitening apparatus as recited in claim 10, wherein the biteplane wall is disposed in a perpendicular orientation relative to the first and second walls.

15. A dental whitening apparatus as recited in claim 1, wherein the first and second walls have rounded edges.

16. A dental whitening apparatus as recited in claim 2, further comprising an electronic circuit disposed with the body, which communicates with the thermal sensor, the thermostat and the energy source for controlling operation of the dental whitening apparatus.

17. A dental whitening apparatus as recited in claim 2, wherein the thermostat has a predetermined upper limit and a predetermined lower limit.

18. A dental whitening apparatus as recited in claim 16, further comprising a rheostat temperature control disposed with the body that communicates with the electronic circuit in a configuration that controls the temperature adjacent the cavity of the dental receiving area at a predefined value.

19. A dental whitening apparatus as recited in claim 16, further comprising a timer disposed with the body that communicates with the electronic circuit in a configuration that transmits heat energy for a predetermined amount of time.

20. A dental whitening apparatus as recited in claim 1, wherein the dental receiving area is contoured to a set of teeth having a full arch configuration.

21. A dental whitening apparatus comprising:
a body including a heating element, a light emitting device and at least one vibratory element, the heating element and the light emitting device being disposed for activating a bleaching composition, the vibratory element being disposed in a configuration for mixing the bleaching composition; and
a mouthpiece mounted with the body, the mouthpiece including a dental receiving area being formed of a polymeric composition that facilitates transmission and emittance of light, and being contoured to a set of teeth, the dental receiving area having a first wall, a second wall, and a biteplane wall extending therebetween, the biteplane wall including a plurality of openings and separating a first compartment and a second compartment of the dental receiving area, the first wall and the second wall defining a first cavity of the first compartment and a second cavity of the second compartment, wherein the first and second cavities are configured for disposal of the bleaching composition, the first and second cavities communicating via the openings.

22. A method for whitening teeth comprising the steps of:
providing a dental whitening apparatus adapted for use with a subject having a set of teeth, the dental whitening apparatus including:
a body including a heating element and a light emitting device, the heating element and the light emitting device being disposed for activating a bleaching composition; and
a mouthpiece connected with the body, the mouthpiece including a dental receiving area being formed of a material that facilitates transmission and emittance of light, and being contoured to a set of teeth, the dental receiving area having a first wall and a second wall that define a cavity, wherein the cavity is configured for disposal of the bleaching composition;
providing a first ingredient of the bleaching composition to the cavity of the dental receiving area;
providing a second ingredient, separate from the first ingredient, of the bleaching composition to the cavity of the dental receiving area;
mixing the first ingredient and the second ingredient in the cavity to form the bleaching composition;
placing the dental whitening apparatus such that the set of teeth are disposed within the cavity of the dental receiving area such that the bleaching composition engages the set of teeth; and
transmitting heat energy from the heating element and light energy from the light emitting device to the bleaching composition engaging the set of teeth for activating the bleaching composition.

23. A method for whitening teeth as recited in claim 22, wherein the steps of mixing includes mixing the first ingredient and the second ingredient for a predetermined period of time.

24. A method for whitening teeth as recited in claim 22, wherein the step of mixing occurs prior to the step of placing.

25. A method for whitening teeth as recited in claim 22, wherein the step of transmitting includes transmitting heat energy and light energy for a predetermined period of time.

26. A method for whitening teeth as recited in claim 22, further comprising the step of providing at least one medication to the bleaching composition, prior to the step of mixing.

27. A method for whitening teeth comprising the steps of:
providing a dental whitening apparatus adapted for use with a subject having a set of teeth, the dental whitening apparatus including:
a body including a heating element, a light emitting device, at least one vibratory element, the heating element and the light emitting device being disposed for activating a bleaching composition, the vibratory element being disposed in a configuration for mixing the bleaching composition;
a mouthpiece mounted with the body, the mouthpiece including a dental receiving area being formed of a polymeric composition that facilitates transmission and emittance of light and being contoured to a set of teeth, the dental receiving area having a first wall, a second wall, and a biteplane wall extending therebetween, the biteplane wall including a plurality of openings and separating a first compartment and a second compartment of the dental receiving area, the first wall and the second wall define a first cavity of the first compartment and a second cavity of the second compartment, wherein the first and second cavities are configured for disposal of the bleaching composition, the first and second cavities communicating via the openings;
providing a first ingredient of the bleaching composition to one of the first and second cavities of the dental receiving area;
providing a second ingredient, separate from the first ingredient, of the bleaching composition to one of the first and second cavities of the dental receiving area to form the bleaching composition;
vibrating the dental receiving area, via the vibratory element, to mix the first ingredient and the second ingredient;
mixing the bleaching composition via passage of the bleaching composition through the openings of the biteplane wall;
placing the dental whitening apparatus such that the set of teeth are disposed within the first cavity and the second cavity such that the bleaching composition engages the set of teeth; and
transmitting heat energy from the heating element and light energy from the light emitting device to the bleaching composition engaging the set of teeth for activating the bleaching composition.

28. A method for whitening teeth as recited in claim 27, wherein the step of vibrating includes vibrating the dental receiving area for a predetermined period of time.

29. A method for whitening teeth as recited in claim 27, further comprising the step of providing at least one medication to the bleaching composition, prior to the step of mixing.

30. A method for whitening teeth as recited in claim 27, further comprising the step of vibrating the dental receiving area and the bleaching composition disposed therein, subsequent to the step of placing, to distribute the bleaching composition about and between the set of teeth.

31. A method for whitening teeth as recited in claim 29, further comprising the step of vibrating the dental receiving area and the bleaching composition, and at least one medication disposed therein, subsequent to the step of placing, to distribute the bleaching composition and the at least one medication about and between the set of teeth and gums of the subject.

32. A method for whitening teeth as recited in claim 27, further comprising the step of vibrating the dental receiving area and the bleaching composition disposed therein, subsequent to the step of placing, to agitate the bleaching composition causing cavitation of the bleaching composition about and in between the set of teeth and gums for cleansing thereof.

33. A method for whitening teeth as recited in claim 27, further comprising the step of activating a vibratory element to cause cavitation of the bleaching composition about and in between the set of teeth and gums for cleansing thereof.

34. A dental whitening apparatus comprising:
a body including an energy emitting device, the energy emitting device being disposed for activating a bleaching composition; and
a mouthpiece in optical communication with the body, the mouthpiece including a dental receiving area being formed of a material that facilitates transmission and emittance of light, and being contoured to a set of teeth, the dental receiving area having a first wall and a second wall that define a cavity,
wherein the cavity is configured for disposal of the bleaching composition.
